(19) United States
(12) Patent Application Publication
(10) Pub. No.: US 2010/0274862 A1
(43) Pub. Date: Oct. 28, 2010

(54) METHODS FOR ESTABLISHING LEGITIMACY OF COMMUNICATIONS

(76) Inventors: John Swain, Boston, MA (US); Mark De Groot, Montreal (CA)

Correspondence Address: FISH & RICHARDSON P.C., P.O. BOX 1022, MINNEAPOLIS, MN, 55440-1022, US

(21) Appl. No.: 12/827,910

(22) Filed: Jun. 30, 2010

Related U.S. Application Data
(63) Continuation of application No. 11/572,042, filed on Nov. 7, 2007, now abandoned.

(30) Foreign Application Priority Data
Jul. 13, 2004 (CA) 2473157

(51) Int. Cl. G06F 15/16

(52) U.S. Cl. 709/206

(57) ABSTRACT

A sender-side process directed to processing an electronic message destined for a recipient, comprising producing a solution to a computational problem involving at least a portion of the message. A degree of effort associated with solving the problem may be assessed. The message is further processed according to the degree of effort by determining whether the degree of effort was within a range set by the sender or the recipient and if not, the computational problem is adjusted and solved again. The message is then transmitted to a recipient, who is informed of both the problem and solution. The recipient executes a recipientside process, comprising: assessing the degree of effort associated with generation of the message based on the problem and solution; and further processing the message in accordance with the degree of effort. The degree of effort is indicative of the legitimacy of the message; e.g., is it “SPAM”.

### FIELD OF THE INVENTION

The present invention relates generally to communications and, more particularly, to methods and systems for establishing the legitimacy of communications.

### BACKGROUND OF THE INVENTION

Unsolicited communication, commonly called “junk mail”, “junk messages”, “junk communications” or “spam”, is a difficult concept to define precisely because the value or interest of a message from a sender to a recipient cannot, in general, be predicted by a third party. Indeed, in many cases it is not even easy for the sender himself (herself) to estimate the value or interest of the message to the recipient (who may be a potential customer, for example) nor would it necessarily be easy for recipient to estimate the value or interest of the message without actually reading it, or at least some part of it.

Once these facts are accepted, it is clear that conventional spam control techniques, which make conclusions about incoming messages based solely on addresses, words and expressions therein, are deficient. Specifically, the use of key words, heuristics, Bayesian filters and the like will overlook carefully crafted junk messages that introduce elements of randomness or unpredictability or insert elements which are designed to give the appearance of being legitimate communications. On the other hand, by setting conventional filters to behave in a highly restrictive fashion, one increases the incidence of “false positives”, which is the phenomenon whereby a message that contains certain earmarks of an unsolicited communication (e.g., key words or hyperlinks), but is actually a legitimate message, will be discarded by the filter instead of being delivered to the intended recipient.

Clearly, therefore, the industry is in need of an alternate solution to countering the incidence of junk messages.

### SUMMARY OF THE INVENTION

In accordance with a first broad aspect, the present invention may be summarized as a method, comprising receiving an electronic message; assessing a degree of effort associated with a generation of the electronic message; and further processing the electronic message in accordance with the assessed degree of effort.

In accordance with a second broad aspect, the present invention may be summarized as a method, comprising: receiving an electronic message; determining whether the electronic message comprises a portion that enables the recipient to assess a degree of effort associated with a generation of the electronic message; and further processing the electronic message in accordance with the outcome of the determining step.

In accordance with a third broad aspect, the present invention may be summarized as a graphical user interface implemented by a processor, comprising: a first display area capable of conveying electronic messages; and a second display area conveying an indication of a legitimacy score associated with any electronic message conveyed in the first display area.

In accordance with a fourth broad aspect, the present invention may be summarized as a graphical user interface implemented by a processor, comprising: an actionable input area for allowing the user to select one of at least three message repositories, each of the message repositories capable of containing electronic messages, each of the message repositories being associated with a respective legitimacy score; and wherein a portion of each electronic message contained in the selected message repository is graphically conveyed to the user.

In accordance with a fifth broad aspect, the present invention may be summarized as a method of processing an electronic message destined for a recipient, comprising: solving a computational problem involving at least a portion of the electronic message, thereby to produce a solution to the computational problem; assessing a degree of effort associated with solving the computational problem; and further processing the electronic message in accordance with the assessed degree of effort.

In accordance with a sixth broad aspect, the present invention may be summarized as a method of sending an electronic message to a recipient, comprising: solving a computational problem involving and at least a portion of the electronic message, thereby to produce a solution to the computational problem; transmitting to the recipient a first message containing the electronic message; informing the recipient of the solution to the computational problem; and transmitting to the recipient trapdoor information in a second message different from the first message. In accordance with this sixth broad aspect, solving a computational problem comprises converting the at least a portion of the electronic message into an original string and executing a computational operation on the original string, and the trapdoor information facilitates solving an inverse of the computational operation at the recipient.

In accordance with a seventh broad aspect, the present invention may be summarized as a method of sending an electronic message to a recipient, comprising: solving a 1^{st} computational problem involving at least a portion of the electronic message, thereby to produce a solution to the 1^{st} computational problem; for each j, 2≦j≦3, solving a j^{th} computational problem involving at least a portion of the electronic message and the solution to the (j−1)^{th} computational problem, thereby to produce a solution to the j^{th} computational problem; transmitting the electronic message to the recipient; and informing the recipient of the solution to each of the 1^{st}, . . . , j^{th} computational problems.

In accordance with an eighth broad aspect, the present invention may be summarized as a method of processing an electronic message destined for a recipient, comprising: obtaining knowledge of an effort threshold associated with the electronic message; solving a computational problem involving at least a portion of the electronic message, thereby to produce a solution to the computational problem; assessing a degree of effort associated with solving the computational problem; and responsive to the assessed degree of effort exceeding the effort threshold, transmitting the electronic message to the recipient and informing the recipient of the solution to the computational problem.

In accordance with a ninth broad aspect, the present invention may be summarized as a method, comprising: receiving a plurality of electronic messages; assessing a degree of effort associated with a generation of each of the electronic messages; and causing the electronic messages to be displayed on a screen in a hierarchical manner on a basis of assessed degree of effort.

The invention may also be summarized as a computer-readable storage medium containing a program element for execution by a computing device to perform the various above methods, with the program element including program code means for executing the various steps in the respective method.

The solutions discussed herein are compatible with many existing approaches and could thus also be used in conjunction with these other approaches as desired.

These and other aspects and features of the present invention will now become apparent to those of ordinary skill in the art, upon review of the following description of specific embodiments of the invention in conjunction with the accompanying drawings.

### BRIEF DESCRIPTION OF THE DRAWINGS

In the accompanying drawings:

FIG. 1 is a conceptual block diagram of a system for communicating electronic messages to recipients, in accordance with a first specific embodiment of the present invention;

FIG. 2 shows steps in a process for transmission of an electronic message by the sender, in accordance with the first specific embodiment of the present invention;

FIG. 3 is a conceptual block diagram of a system for processing received electronic messages from senders, in accordance with the first specific embodiment of the present invention;

FIGS. 4A and 4B show steps in a process executed upon receipt of an electronic message at the recipient, in accordance with the first specific embodiment of the present invention;

FIGS. 5 and 6 depict elements of a GUI used to convey information about electronic messages received by a recipient, in accordance with embodiments of the present invention;

FIG. 7 is a conceptual block diagram of a system for communicating electronic messages to recipients, in accordance with a second specific embodiment of the present invention;

FIG. 8 shows steps in a process for transmission of an electronic message by the sender, in accordance with the second specific embodiment of the present invention;

FIG. 9 is a conceptual block diagram of a system for processing received electronic messages from senders, in accordance with the second specific embodiment of the present invention;

FIGS. 10A and 10B show steps in a process executed upon receipt of an electronic message at the recipient, in accordance with the second specific embodiment of the present invention;

FIG. 11 shows steps in a process for transmission of an electronic message by the sender, in accordance with a third specific embodiment of the present invention;

FIG. 12 shows steps in a process executed upon receipt of an electronic message at a recipient, in accordance with the third specific embodiment of the present invention;

FIG. 13 shows steps in a process for transmission of an electronic message by a sender, in accordance with a fourth specific embodiment of the present invention in which urgency is a factor;

FIG. 14 shows steps in a process executed upon receipt of an electronic message at a recipient, in accordance with the fourth specific embodiment of the present invention in which urgency is a factor;

FIG. 15 shows steps in a process for transmission of an electronic message by a sender, in accordance with yet another embodiment of the present invention;

FIG. 16 shows steps in a process for transmission of an electronic message by a sender, in accordance with still a further embodiment of the present invention;

FIG. 17 is a conceptual block diagram of a system for communicating electronic messages between a sender and a recipient, in accordance with another embodiment of the present invention.

It is to be expressly understood that the description and drawings are only for the purpose of illustration of certain embodiments of the invention and are an aid for understanding. They are not intended to be a definition of the limits of the invention.

### DETAILED DESCRIPTION OF EMBODIMENTS

In the following, there will be described a sender-side process and a recipient-side process. The sender-side process is directed to processing an electronic message destined for a recipient, and comprises solving a computational problem involving at least a portion of the message, thereby to produce a solution to the problem. Optionally, a degree of effort associated with solving the problem may be assessed and the message is further processed in accordance with the assessed degree of effort. Further processing refers to determining whether the degree of effort was within a range set by the sender or the recipient and if not, the computational problem is adjusted and solved again. The message is then transmitted to the recipient, who is informed of both the solution to the problem and the problem itself. The recipient executes the recipient-side process, which includes, upon receipt of the message: assessing the degree of effort associated with generation of the message using its knowledge of the problem and the solution; and further processing the message in accordance with the assessed degree of effort. High and low degrees of effort, respectively, will point to electronic messages having high and low legitimacy, respectively.

### Sender-Side Messaging Client 102

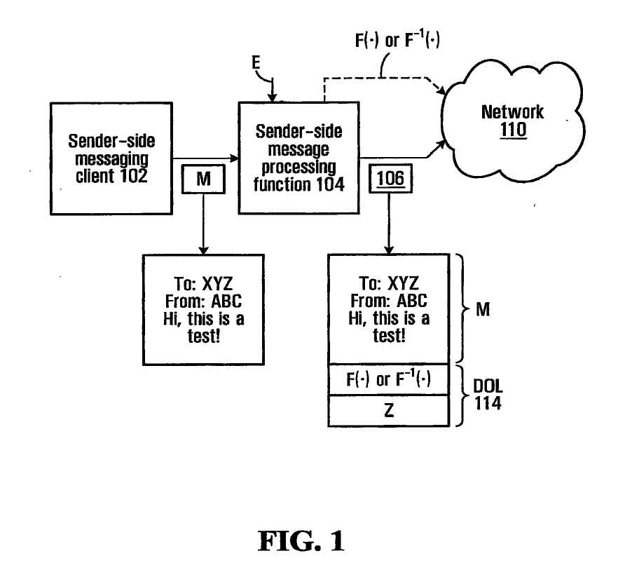

With reference to FIG. 1, a sender-side messaging client 102 generates an original message (hereinafter denoted by the single letter M) originating from a sender. The sender-side messaging client 102 may be implemented as a software application executed by a computing device to which the sender has access via an input/output device (I/O). Examples of the computing device include without being limited to a personal computer, computer server, cellular telephone, personal digital assistant, networked electronic communication device (e.g., portable ones such as Blackberry™), etc.

The original message M may be an email message. However, it should be appreciated that the original message M is not limited to an email message and may generally represent any communication or transfer or data. Specifically, the original message M may contain a digital rendition of all or part of a physical communication such as conventional mail including letters, flyers, parcels and so on; text and/or video or other messages without limitation sent on phones; instant messages (i.e. messages sent via real time communication systems for example over the interne* faxes; telemarketing calls and other telephone calls; an instruction or instructions to a target computer such as a web-server; more generally to any information or communication sent by any electronic system for transmitting still or moving images, sound, text and/or other data; or other means of communicating data or information.

In the specific case where the original message M is an email message, the original message M may contain, without limitation, a portion identifying a sender, a portion identifying a recipient, a portion identifying ancillary data, a portion identifying the title or subject, a portion that comprises a message body, and a portion that comprises file attachments. The portion that identifies ancillary data may specify spatio-temporal co-ordinates such as, without limitation, time, time zone, geographical location of the sender, or any other significant information as desired. Alternatively, there may be no specific portion dedicated to ancillary data or such ancillary data could be considered a part of the message body.

Examples of such other ancillary data include parameters that are time-dependent in nature and subject to verification, such as a numerical key held by some party, or a publicly available and verifiable datum (for instance an unpredictable one such as the opening price of some stock in some market on some day, etc.) or alternatively some datum, possibly provided by a third party in exchange for consideration as a commercial venture, which is generated by secure, deterministic or random techniques. Such information could be used in order to ensure that a message could not possibly have been generated and subjected to the algorithms which are described herein prior to some given time when this ancillary data did not exist. This in turn can be used to ensure that whatever computational and other resources are brought to bear in order to effect the algorithms described here must be done in the recent past (according to some definition), and could not have been done using slow techniques or low performance computational resources over a long period of time.

The original message M generated by the sender-side messaging client 102 is sent to a sender-side message processing function 104. The sender-side message processing function 104 may be implemented as a software application executed by a computing device to which the sender has access via an I/O. Examples of the computing device include without being limited to a personal computer, computer server, cellular telephone, personal digital assistant, networked electronic communication device (e.g., portables ones such as Blackberry™), etc. Moreover, the sender-side message processing function 104 may be a sub-application of the sender-side messaging client 102.

### Sender-Side Message Processing Function 104

In accordance with embodiments of the present invention, the onus is put on the sender to demonstrate to the recipient that a communication is likely to be worth reading and also that the sender assigns importance to having a specific recipient read or otherwise process the communication. To this end, embodiments of the present invention utilize a tag that can be affixed to the original message M by the sender-side message processing function 104. The tag, hereinafter referred to as a “demonstration of legitimacy” (or “DOL”) and denoted 114 in FIG. 1, testifies to a certain degree of effort having been expended by the sender, in a manner chosen by the sender. The degree of effort expended by the sender can be assessed quantitatively (e.g., as an amount of something) or qualitatively (e.g., as being characterized in some way), which information can in turn be used to determine how to handle the communication.

To this end, the sender-side message processing function 104 executes a process to solve a computational problem involving at least a portion of the original message M. In the course of solving the computational problem, the sender-side message processing function 104 expends a certain degree of effort. In accordance with an embodiment of the present invention, the sender-side message processing function 104 attempts to ensure that the degree of effort expended in solving the computational problem will be at least as great as a “minimum threshold effort” (hereinafter denoted by the single letter E). In other embodiments of the present invention, the sender-side message processing function 104 attempts to ensure that the degree of effort expended in solving the computational problem falls within a pre-determined range.

In various example embodiments, the degree of effort is assessed quantitatively or qualitatively. Accordingly, the minimum threshold effort E may defined in a quantitative manner (e.g., CPU cycles, time, etc.) or in qualitative manner value (e.g., a restriction on the sizes and number of prime factors of <M>, or a combination thereof, as is discussed further below). An indication of the minimum threshold effort E may be provided explicitly by the sender on a message-by-message basis, or it may be initialized to a specific value, or it may be set on some other basis or communicated in some other manner.

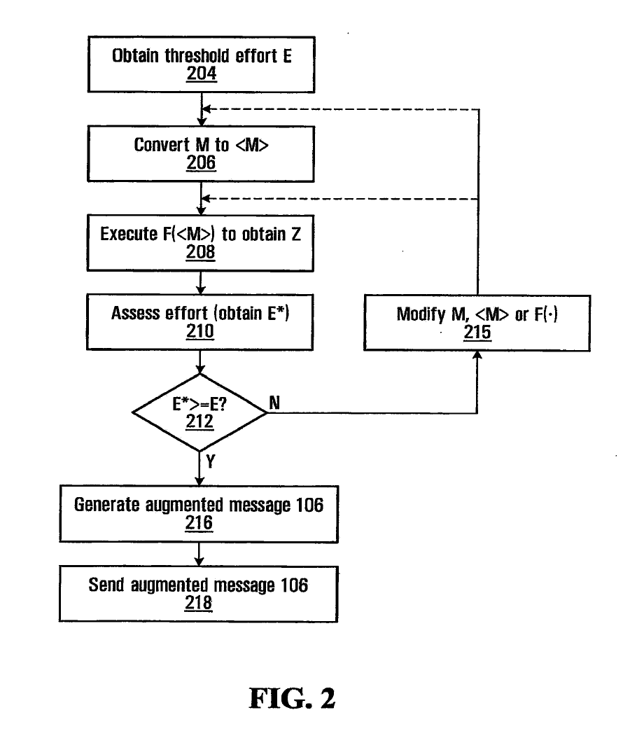

With reference to FIG. 2, a specific non-limiting example embodiment of the process executed by the sender-side message processing function 104 is shown. Specifically, the original message M is inputted. At step 204, the sender-side message processing function 104 obtains knowledge of the minimum threshold effort E. It is recalled that the minimum threshold effort E may be specified by the sender on a message-by-message basis or it may be set to a specific value, for example, a default value.

At step 206, the sender-side message processing function 104 attempts to solve the computational problem involving the original message M by first converting the original message M into a string hereinafter denoted “<M>”. For instance, the string may be a string of ones and zeroes, bytes, characters, etc.

While for the purposes of the present example, it is assumed that the entire original message M is converted into a string, it should be understood that in other embodiments, only part of the original message M (e.g., the portion identifying the ancillary data and a subset of the message body) may be used. In an example, conversion as contemplated by step 206 may be effected by concatenating the string of bytes which are representative of the original message M or the relevant portions thereof (for example by means of the ASCII or American Standard Code for Information Interchange) into a single decimal number.

At step 208, the sender-side message processing function 104 executes a computational operation on the string <M>. Specifically, in this embodiment, the computational operation is defined by a function F(•), thus the computational problem can be expressed as F(<M>), yielding a solution that is hereinafter denoted by the single letter “Z”. The function F(•) may be referred to as a “work” function.

At step 210, the sender-side message processing function 104 assesses the effort that was expended in solving the computational problem. In some embodiments, the assessment of expended effort is made by measuring the computational complexity of the computational problem, which can be done in a variety of ways such as by tracking elapsed time, counting CPU cycles, etc. The expended effort is denoted E*. In some embodiments of the present invention, the sender-side message processing function 104 infers the degree of effort expended in solving the computational problem using empirical techniques that are based on characteristics of the solution Z.

The sender-side message processing function 104 then proceeds to step 212, where the expended effort E* is compared to the minimum threshold effort E. If the expended effort E* is less than the minimum threshold effort E, the sender-side message processing function 104 proceeds to step 214, where the computational problem to be solved is modified so as to make it more computationally intensive.

For example, the function F(•) may be modified to make it a more computationally intensive function, in which case the sender-side message processing function 104 returns to step 208. Alternatively, the string <M> may be modified to make computation of F(<M>) more difficult, in which case the sender-side message processing function 104 also returns to step 208.

In another embodiment, which may be applied in conjunction with the aforementioned modification to the function F(•), the original message M is modified to make computation of F(<M>) more difficult, in which case the sender-side message processing function 104 returns to earlier step 206. This can be referred to as adding “pepper” to the original message M.

Those skilled in the art will appreciate that the minimum threshold effort E is likely to be set to a high value. However, care should be taken so as to minimize occurrences of the situation in which the recipient's computational resources will be monopolized or otherwise overused when attempting to assess the computational effort expended by the sender. Thus, the function F(•) should be chosen judiciously, as is now described.

One example of a function that may be suitable is a “one-way function” F(•) as used in cryptography, number theory and elsewhere. In general terms, a one-way function is a function that is difficult to compute in one direction but easy to compute in the inverse direction. As one description of one-way functions, without limitation, one has the following definition taken from Handbook of Applied Cryptography, by A. Menezes, P. van Oorschot, and S. Vanstone, CRC Press, 1996, page 8 (which actually refers to the inverse of a one-way function as used throughout this specification and thus is capitalized):
Definition 1.12 A function f from a set X to a set Y is called a ONE-WAY FUNCTION if f(x) is “easy” to compute for all x∈X but for “essentially all” elements y∈Im(f)[or Image[f]] it is “computationally infeasible” to find any x∈X such that f(x)=y.
1.13 Note (clarification of terms in Definition 1.12)
(i) A rigorous definition of the terms “easy” and “computationally infeasible” is necessary but would detract from the simple idea that is being conveyed. For the purpose of this chapter [Chapter 1], the intuitive meaning will suffice.
(ii) The phrase “for essentially all elements in Y” refers to the fact that there are a few values y∈Y for which it is easy to find an x∈X such that y=f(x). For example, one may compute y=f(x) for a small number of x values and then for these, the inverse is known by table look-up. An alternate way to describe this property of a ONE-WAY FUNCTION is the following: for a random y∈Im(f) it is computationally infeasible to find any x∈X such that f(x)=y.

In more intuitive terms, a one-way function as contemplated by the present invention may be exemplified by, although by no means limited to, the factoring of numbers into their prime constituents (prime factors). A subset of such problems is the problem of factoring a product of two or more large prime numbers into its prime factors. That is to say, given two large prime numbers it is a computationally simple task to find their product, while given only their product, finding the primes is generally progressively more computationally intensive as the number to be factored increases in size.

Another example is given by the determination of discrete logarithms. (For instance, while a putative solution of the equation 3^{x}=7 mod 13 is easy to verify, it may require significant effort to find a solution, viz., how many times 3 must be multiplied by itself in order that the product leave a remainder of 7 on division by 13.) There are many other examples of problems of this kind where the work required to solve them is large compared to the work required to check or validate the putative solution. Throughout this specification, the term “one-way function” is used in its broadest sense, although the prime factoring problem is used as a specific implementation.

Returning now to the flowchart in FIG. 2, it should be understood that in the majority of cases, step 212 will eventually yield the result that the expended effort E* is greater than or equal to the minimum threshold effort E. When this occurs, the sender-side message processing function 104 constructs an augmented message 106 at step 216, which comprises the original message M and a DOL 114 that includes Z (i.e., the solution to the computational problem). In those cases where the condition of step 212 is not satisfied even after a given (e.g., large) amount of time or number of attempts, then as a default measure, it is within the scope of the invention to exit the loop nevertheless and perform step 216 by constructing the augmented message 106 from the original message M and, say, the most recently generated DOL or the most “difficult” of the generated DOLs 114 or all of the generated DOLs 114, etc. This provides an explicit solution if the problems being generated turn out to be too easy or too hard for too many attempts.

The DOL 114 may additionally include a definition of the function F(•) (or its inverse F⁻¹(•)) plus whatever information is necessary to describe how M or <M> was modified in order to give rise to the appropriate expression of effort conveyed by the DOL 114; alternatively (see dashed lines in FIG. 1), this information may be communicated over the data network 110 to the recipient in a separate message or via separate channel (e.g., for enhanced security). It is noted that by “definition” of a particular function, this also includes referring to the particular function by an index of a set of functions mutually agreed upon between sender and recipient.

It will thus be appreciated that the sender-side message processing function 102 ensures that the DOL 114 generated at step 214 constitutes genuine evidence that a certain minimum effort was expended, thereby avoiding situations analogous to ones in which a mass mailing company would stamp its envelopes (delivered via regular mail) with the words “Courier Mail” in order to give the impression that the correspondence had been delivered at extra expense or with extra effort.

In addition to checking that the effort expended E* is not too small, one can also check that the expended effort E* is also not too large. In other words, it is envisaged that the expended effort E* will be compared to a threshold range rather than only the minimum threshold effort E.

One could also in certain embodiments ensure that the minimum threshold effort E for a given message decreases as one cycles through modified problems to ensure that one did not find oneself in a situation where a message unexpectedly took an inordinate (by some measure) amount of time to send. Of course, if this still does not result in the condition of step 212 being satisfied, then the aforementioned default measure can still be applied.

It should also be understood that execution of the process of FIG. 2 can be optimized from the sender's point of view so as not to paralyze (or otherwise unduly slow the execution of) other tasks being executed by the computing device that implements the sender-side message processing function 104. How best to do this is somewhat dependent on hardware and operating system considerations, but one general approach would include running the process of FIG. 2 at a low priority and letting the operating system manage the details of how CPU cycles are allocated to the DOL-generation process. A related approach is to force the process to run only on every n^{th} clock cycle. The use of every n^{th} cpu cycle can also be used to defeat attempts to use cheap/parallel approaches to DOL generation.

Returning now to the flowchart in FIG. 2, at step 218, the augmented message 106 (consisting of the original message M and the DOL 114) is communicated to the recipient (e.g., via a data network 110).

### Recipient-Side Message Processing Function 302

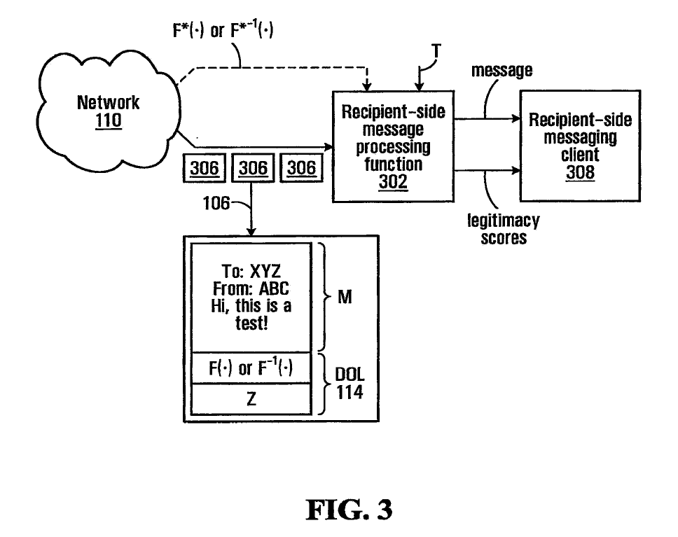

With reference to FIG. 3, at the recipient, the augmented message 106 is received by a recipient-side message processing function 302, which may be implemented as a software application executed by a computing device to which the recipient has access via an 110. Examples of the computing device include without being limited to a personal computer, computer server, cellular telephone, personal digital assistant, networked electronic communication device (e.g., portable ones such as Blackberry™), etc.

As described above, the augmented message 106 comprises a first part that constitutes the original message M as well as a second part that constitutes the DOL 114 which comprises the solution Z. In addition, the DOL 114 may comprise the definition of the function F(•) (or its inverse F⁻¹(•)) used to generate the solution Z as well as any modifications to M or <M>. Alternatively (see dashed lines in FIG. 3), this information may be provided to the recipient in a separate message or via a separate channel.

It should be understood that in general, the recipient receives messages 306 that include messages other than the augmented message 106. Each of the received messages 306 may or may not contain a DOL and, if they contain a DOL, such DOL may or may not be “valid” (i.e., one which expresses the correct solution to a problem involving all or part of the associated message 306). Accordingly, the recipient-side message processing function 302 executes a process that begins by verifying whether a particular received message 306 contains a DOL and, if so, whether the DOL is valid and, if so, whether adequate effort was expended by the sender.

It should also be understood that if the received messages 306 do contain a DOL, this does not mean that these messages were generated using the above-described technique where the sender assessed its own degree of effort in solving a computational problem. In other words, the sender-side and recipient-side processes are not dependent on one another. In other words, while the degree of effort expended by the sender in generating a message is assessed at the recipient, this does not require that the sender had assessed its own degree of effort before sending the message. Instead, the sender, may simply have advance knowledge that the solution to a particular computational problem is likely to fall within a certain range with a certain probability.

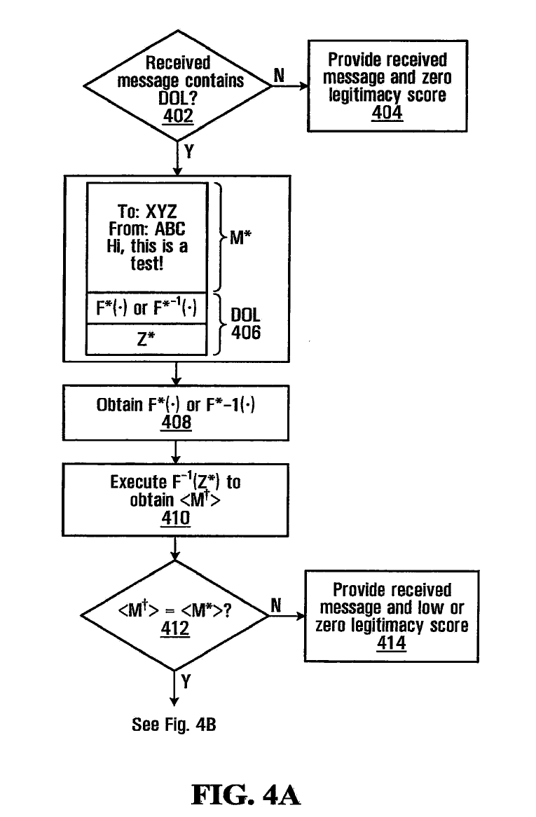

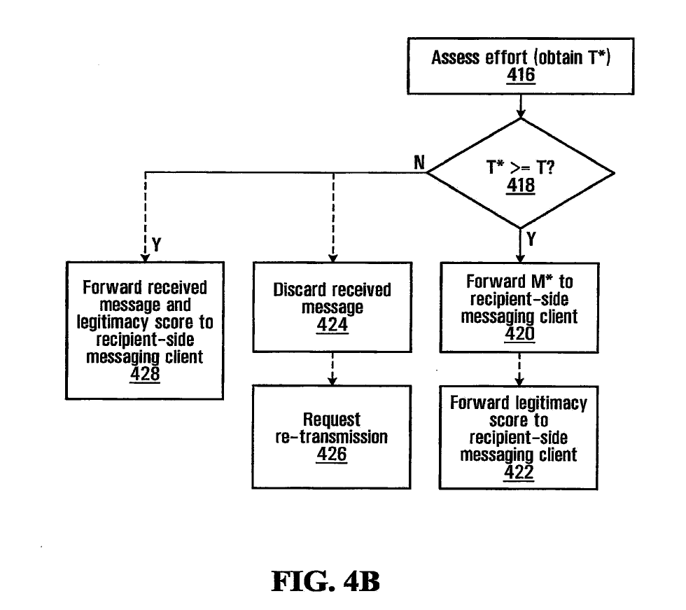

With reference to FIGS. 4A and 4B, a specific non-limiting example embodiment of the process executed by the recipient-side message processing function 302 is shown. Specifically, at step 402, the recipient-side message processing function 302 determines whether the received message 306 contains a putative DOL. If not, it can be said that the received message 306 carries a zero “legitimacy score”. Accordingly, at step 404, both the received message 306 and the legitimacy score are provided to a recipient-side messaging client 308 for further processing. Alternatively, the received message 306 may be discarded.

However, if the received message 306 contains a putative DOL, then this means that the received message 306 is an augmented message which comprises an original message M* and a putative DOL 406, which comprises a solution Z* to a computational problem, the definition of which has been provided to the recipient-side message processing function 302. The recipient-side message processing function 302 thus proceeds to establish the validity of the putative DOL 406.

Specifically, at step 408, the recipient-side message processing function 302 obtains knowledge of the inverse F*⁻¹(•) of the function F*(•) thought to have been used by the sender in computing the solution Z*. It will be understood that where the received message 306 is the augmented message 106, then the function F*(•) will correspond to the function F(•) and the asterisks in the following discussion can be ignored.

In certain embodiments, the definition of the function F*(•) or of its inverse F*⁻¹(•) will have been contained in the received DOL 406. If the received DOL 406 contains the definition of the function F*(•), then its inverse needs to be obtained, although this is straightforward to do, particularly for one-way functions. For example, consider the case where the function F*(•) corresponds to prime factoring. The inverse is simply the operation of multiplying the factors to obtain the product.

Next, at step 410, the recipient-side message processing function 302 applies the inverse F*⁻¹(•) to the received solution Z*, thereby to obtain a reconstructed string <M^{\}>. At step 412, the reconstructed string <M^{\}> is compared to the string <M*> that can be obtained from the original message M*. If there is no match, then the recipient-side message processing function 302 can immediately conclude that the received DOL 406 is invalid or bogus. Thus, it can be said that the received message 306 carries a low or zero “legitimacy score”. Accordingly, at step 414, both the original message M* and the legitimacy score are provided to the recipient-side messaging client 308 for further processing. Alternatively, the received message 306 may be discarded.

However, assuming that there is a match between <M^{\}> and <M*> at step 412, the recipient-side message processing function 302 proceeds to execute a sub-process that will now be described with reference to FIG. 4B.

Specifically, at step 416, the degree of effort expended in association with a generation of the received message 306 is assessed and in some embodiments can be quantified as T*. This can be done in a brute force manner, e.g., by solving the same computational problem as the sender, i.e., F*(<M*>), and determining the time or CPU cycles required to produce the solution. Alternatively, the recipient-side message processing function 302 may render its own independent assessment without needing to perform the brute force calculation, based on knowledge of the function F*(•) and possibly knowledge of the solution Z*.

For example, consider the case where F*(•) corresponds to factoring into prime numbers. Generally speaking, knowing that <M*> is a large number, one can expect that correctly factoring <M*> into its prime constituents is a difficult task, when compared to an “easier” function such as finding the square root. However, it may be possible that some values of the string <M*>, albeit large, are relatively simple to factor into prime numbers. For instance, powers of 10 fall into this category. Thus, knowledge of <M*> in addition to knowledge of F*(•) both contribute to obtaining an accurate or at least approximate assessment of the effort expended in association with generation of the received message 306.

Next, at step 418, the assessed effort T* is compared to a minimum threshold effort T. The minimum threshold effort T corresponds to a minimum effort required to have been expended in association with generation of a particular message in order for that message to be considered legitimate (i.e., to have a high legitimacy score). The minimum threshold effort T may be configurable by the recipient and may be the same as or different from the minimum threshold effort E used by the sender in some embodiments as described above.

If the assessed effort T* is at least as great as the minimum threshold effort T, then the recipient-side message processing function 302 proceeds to step 420, where the original message M* is forwarded to the recipient-side messaging client 308. In addition, a legitimacy score may be assigned to the received message 306 and, at step 422, forwarded to the recipient-side messaging client 308. The legitimacy score may be correlated with the extent to which the assessed effort T* exceeds the minimum threshold effort T.

However, if the assessed effort T* falls below the minimum threshold effort T, then a variety of scenarios are possible, depending on the embodiment. For example, at step 424, the recipient-side message processing function 302 discards the received message 306 and, optionally at step 426, requests that the received message 306 be re-transmitted by the sender. Alternatively, at step 428, the received message 306 is sent to the recipient-side messaging client 308 along with an indication of a low or zero legitimacy score.

### Recipient-Side Messaging Client 308

The recipient-side messaging client 308 may be implemented as a software application executed by a computing device to which the recipient has access via an I/O. Examples of the computing device include without being limited to a personal computer, computer server, cellular telephone, personal digital assistant, networked electronic communication device (e.g., portables ones such as Blackberry™), etc. In an embodiment, the recipient-side messaging client 308 implements a graphical user interface (GUI) that conveys to the recipient the various received messages 306 and their associated legitimacy scores.

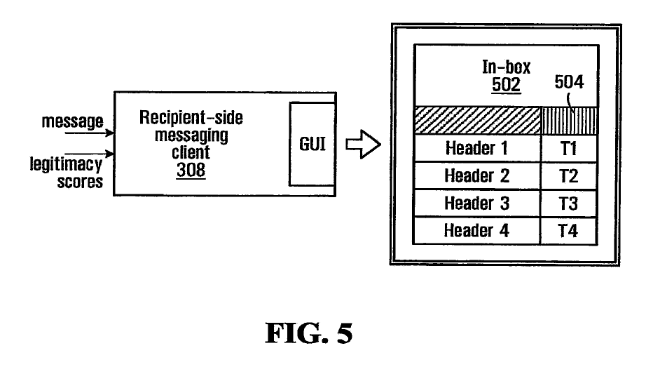

For instance, with reference to FIG. 5, the GUI implements an “in-box” 502 which conveys a plurality of message headers 1 . . . 4 (e.g., sender address, date, title, etc.), as well as a legitimacy score T1 . . . T4 for each message. In addition, and optionally, there is provided an actionable display area (e.g., button) 504 which, when clicked by a user, causes the recipient-side messaging client 308 to sort the messages in accordance with the legitimacy score in ascending or descending order. Thus, for example, the recipient can instantly obtain a glimpse of which received messages have the highest legitimacy score.

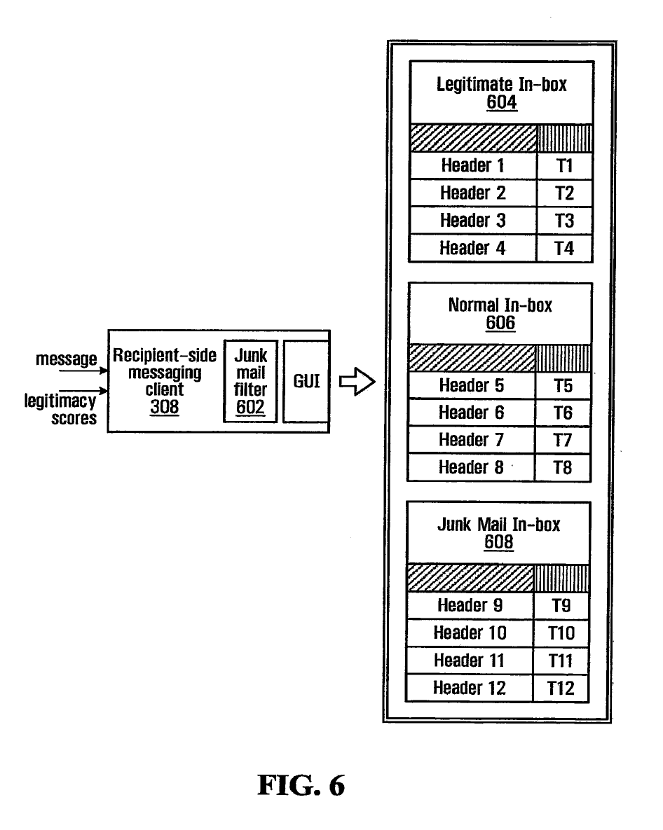

Alternatively, with reference to FIG. 6, the recipient-side messaging client 308 executes a junk mail filter 602 only on received messages that have a low or zero legitimacy score (e.g., received messages not accompanied by a DOL or accompanied by an invalid DOL 406 or accompanied by a valid DOL 406 but nonetheless having a low or zero legitimacy score). In this way, a received message having a high legitimacy score will override the junk mail filter 602, regardless of how susceptible the content of the received message may be to being considered junk mail by the junk mail filter 602. By guaranteeing the delivery of legitimate messages, this approach addresses the issue of so-called “false positives”.

As an example junk mail filter 602, a conventional junk mail filter (e.g., Bayesian, etc.) could be employed, based on all or part of each received message falling in this category. As a result, received messages having a “high” legitimacy score (e.g., above a the minimum threshold effort T) are displayed by the GUI in a “legitimate in-box” 604 (headers 1 . . . 4 and legitimacy scores T1 . . . T4), received messages having a “low” legitimacy score and considered by the junk mail filter to be junk messages are displayed by the GUI in a “junk in-box” 608 (headings 9 . . . 12 and legitimacy scores T9 . . . T12, which may all be zero), whereas the balance, i.e., received messages having a low (or zero) legitimacy score but not classified as junk messages by the junk mail filter, are displayed by the GUI in a “normal in-box” 606 (headers 5 . . . 8 and legitimacy scores T5 . . . T8).

Of course, the definitions of “high” and “low” with respect to the legitimacy score can be specified by the recipient as well as by the sender, who may wish to express various degrees of legitimacy through greater or lesser expenditure of effort in the generation of a DOL. Also, those skilled in the art will appreciate that there is a wide variety of other ways in which a GUI could be designed to reflect a received message's legitimacy score for the benefit of the recipient.

Advantageously, the recipient-side messaging client 308 and the embodiment of the GUI described with reference to FIG. 6 operate unhampered by the lack of DOLs in today's messaging systems, while at the same time they are prepared for the day when DOLs will come into widespread use as contemplated herein.

In addition, the recipient-side messaging client 308 and its GUI allow the recipient to more efficiently allocate time to reading electronic messages, since messages in the “legitimate in-box” are known to be legitimate, whereas messages in the “normal in-box” deserve attention to capture legitimate senders of email who may not have used a DOL (a decreasing percentage of senders over time, it is envisaged), and messages in the “junk mail in-box” deserve only enough attention to filter out the occasional “false positives” (i.e., a message that has a low or zero legitimacy score and is not junk mail but has certain characteristics of junk mail that were flagged by the junk mail filter nonetheless).

In a variant of the above multi-tier inbox embodiment of FIG. 6, the GUI implemented by the recipient-side messaging client 308 displays only the “legitimate in-box” 604 (headings 1 . . . 4 and legitimacy scores T1 . . . T4), with the other in-boxes 606 and 608 being accessible through an actionable button and only by supplying a user-configurable password, or alternatively not being accessible at all. The user can thus only see valid-DOL-tagged messages, and other messages (whether in the normal inbox 606 or the junk inbox 608) are rendered inaccessible to those who do not know the password (or simply rendered inaccessible, i.e., effectively discarded). This approach allows, for example, parents to create a secure “sandbox” for their children to e-mail in, which guarantees that the children will not get spam, much of which contains subject matter (e.g., pornography, etc.) that is unsuitable for children.

### Embodiment Using Hash Function

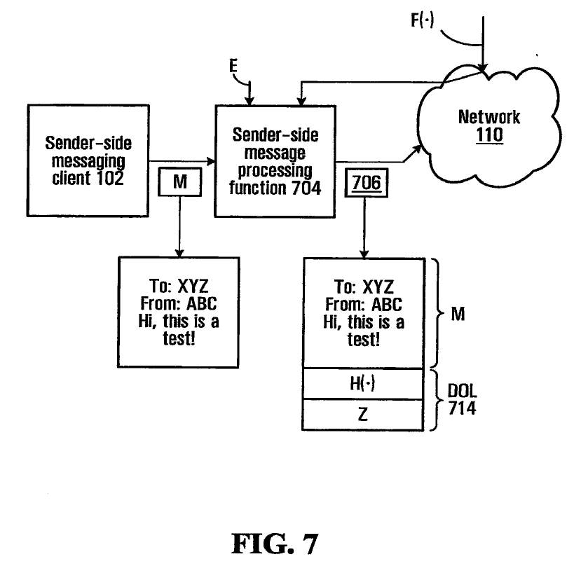

As described earlier, conversion of M into <M> as contemplated by step 206 of FIG. 2 may without limitation be effected by concatenating the string of bytes representative of the original message M (or the relevant portions thereof) into a single value. However, for lengthy messages, this may yield such a high value that execution of the function F(<M>) would take an excessive amount of time and becomes impracticable. On the other hand, for very short messages, this technique results in relatively short numbers that are simple to factor into their prime constituents. Therefore, and as shown in FIG. 7, it is within the scope of the present invention to apply a hash function H(•) to the original message M so as to ensure, for example, that the numerical result of the hash function will be in a desired range. A hash function is a function which assigns a data item distinguished by some “key” into one of a number of possible “hash buckets” in a hash table. For example a function might act on strings of letters and put each string into one of twenty-six lists depending on the first letter of the string in question.

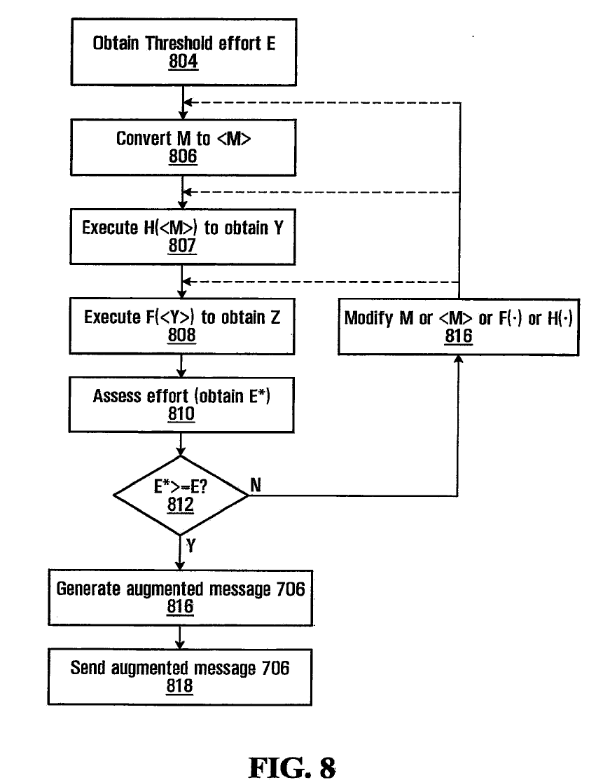

The use of a hash function is now described in greater detail with reference to FIG. 8, in which a specific non-limiting example embodiment of the process executed by the sender-side message processing function 104 is shown. Specifically, after the original message M is inputted, the sender-side message processing function 704 at step 804 obtains knowledge of the minimum threshold effort E. It is recalled that the minimum threshold effort E may be a quantitative value or it may be more loosely defined (e.g., a restriction on the sizes and number of prime factors of <M>, or a combination thereof). Also, it is recalled that the minimum threshold effort E may be specified by the sender on a message-by-message basis or it may be set to a specific value, for example, a default value.

At step 806, the sender-side message processing function 704 attempts to solve the computational problem involving the original message M by first converting the original message M into a string hereinafter denoted “<M>”. While for the purposes of the present example, it is assumed that the entire original message M is converted into numeric form, it should be understood that in other embodiments, only part of the original message M (e.g., the portion identifying the ancillary data and a subset of the message body) may be used. In an example, conversion as contemplated by step 806 may be effected by concatenating the string of bytes representative of the original message M (or the relevant portions thereof) into a single decimal number.

The sender-side message processing function 704 then executes a computational operation on <M>. Specifically, in this embodiment, the computational operation is defined by a “hash function” H(•) followed by a “work function” F(•). Accordingly, at step 807, the sender-side message processing function 704 executes the hash function H(•) on <M>, yielding a result that is hereinafter denoted by the single letter “Y”.

Any convenient and sufficiently complex hash function H(•) can be used. In one example, the hash function H(•) ensures that different parts of the original message M (e.g., the portion identifying the recipient, the portion identifying the ancillary data, the message body, etc.) are included in the result Y. It may also be advantageous for the hash function to be non-local so that small changes to the message (e.g., the portion identifying the recipient) result in changes to the result which are difficult to predict, thereby making it difficult for a spammer to dupe the recipient into thinking that genuine effort was expended by modifying the original message in such a manner that results in a simple computation needing to be performed (or alternatively, results in a hard-to-perform computation which the spammer has, however, already done). Many existing hash functions satisfy these requirements and can readily be adopted with little or no change for the purposes of this invention.

The range of the hash function H(•) need not be fixed, nor completely predetermined, nor unique for all possible messages; it could itself be some function of the various portions of the original message M. A simple example would be to convert the whole message body plus the portion identifying the recipient into a large number (using for example the ASCII code for assigning numerical values to the letters in the Roman alphabet, numbers, control signals, typographic characters and other symbols) and consider the remainder modulo some large prime number, together with some algorithm for ensuring that one obtains n digits (should one choose in a particular implementation to have all output strings be of a specific length n). This example is simplified and purely for illustration. There are many choices which would be apparent to anyone skilled in the art and thus need not be expanded upon here. In any event, the result of the hash function yields Y, which is a number that bears some relationship to the original message M.

For some applications it may be desirable to use a hash function which is executed on only part of the original message M, in the interest of speed, for those applications where time or resources may be too limited—for example on the sender side—to use a hash function H(•) which is executed on more (or all) of the message. Possible instances where this might be useful include, without limitation, real-time communications such as voice communications via telephone, cell phone, voice over IP (VoIP), personal digital assistant, networked electronic communication device (e.g., portable ones such as Blackberry™), etc.

Moreover, it is within the scope of the present invention to use any conceivable hash function H(•), which may be: publicly known; selected by any subset of users who wish to form their own circle of DOL-certified messages; or kept as a (trade) secret which would have to be reverse-engineered from the actual software generating or checking the DOLs—which can be made arbitrarily computationally difficult to do.

Indeed DOLs generated via different hash and/or work functions can be used to mark messages as originating from a specified group or for a specific purpose or set of purposes and thus used as a technique of establishing not only legitimacy but also origination from a group. Different hash and/or work functions could also be used for conveying different information, such as for example whether it is important that the message be ready right away or whether it could be read at the recipient's leisure. As an example, within a company, email messages referring to different projects or tasks could be tagged and identified using different DOL generation algorithms so that automatic classification could be done of messages originating from the same user (i.e. sender) having had the same or different degrees of work performed on them. The use of different DOL generation schemes for various applications and within various groups or for various tasks, or to convey different degrees of importance etc., can be done based on previously made agreements or in response to an initial communication in which the receiver specifies to a sender the required DOL generation algorithm for messages from that sender in order to be considered as belonging to a group, task etc. (or alternatively in which a sender specified that henceforth messages from the sender relating to a given group, task etc. will have their DOLs generated in a specified manner).

At step 808, the sender-side message processing function 704 executes the work function F(•) on Y, yielding a result that is hereinafter denoted by the single letter “Z”. Thus, it is noted that Z=F(Y)=F(H(<M>)). An example of a suitable work function F(Y) is one which factors Y into primes p1, p2, p3, . . . In this case, it would be advantageous if the result Y of the hash function H(•) were large enough that modern factoring techniques require a “significant” but not “excessive” time to run. Similar considerations apply to other work functions F(•). By way of a non-limiting example, the terms “significant” and “excessive” mentioned above can be taken to mean the following:
“significant”: The recipient knows an effort has been made such that a received message is unlikely to be part of a large indiscriminate spam attack. For example, there are about 3×10⁷ seconds in a year, so if the sender spent 1000 seconds, which is a little under 17 minutes, the recipient would know that the sender is not sending more than about 30,000 mails per year (less than 100 per day) and thus is unlikely to be a spammer. In this regard, it is noted that e-mail, by its very nature, is not intended or expected to be particularly fast, except perhaps in certain circumstances between people who know each other (for example colleagues at work who are collaborating on a project with tight deadlines), so this sort of expenditure of CPU should be a small burden for legitimate communicants, such as those who want to make contact with previously unknown recipients. In fact, the present invention also contemplates the scenario in which known parties who are, for example, collaborating in order to meet an urgent deadline, could if deemed useful agree to waive the requirement for a DOL between them for an agreed period of time or in accordance with any other agreed-upon approach.
“excessive”: Whatever the sender is forced to calculate, it should not take so long that there is basically no way for him or her to get the message out in a reasonable length of time (or, alternatively, a reasonable number of messages out per day).

Clearly the terms “significant” and “excessive” depend on context, so that what might be required for email messages could be more (or less) substantial relative to that required in other contexts such as text messages, Short Message Service (SMS) messages and instant messages (IMs), transmitted between mobile telephones, for example.

Just as it may be advantageous for the hash function H(•) to be non-local, it may also be advantageous for the work function F(•) to be non-local as well, so that different outcomes of the hash function H(•) will result in widely different outcomes of F(H(•)). Thus, prime factoring is a suitable example of a non-local work function F(•). Also in the specific case of prime factoring, it is to be noted that even if the hash function H(•) has the property that 1 out of say 1,000,000 e-mails gives a result that is easy to factor into its prime constituents, this is of no real consequence, because for a spammer, the fact that 1 e-mail is easy to send does not help at all if the remaining 999,999 are hard (i.e. time consuming) to send.

As a specific example of steps 806, 807 and 808, consider the following message in italics, viewed as an ASCII string:
Date: Thu, 1 Jul. 2004 16:22:57-0400 (EDT)
From: sender sender@somewhere.org
To: recipient recipient@somewhere-else.org
Subject: a test message
Hi there . . . this is a test!

In binary notation this is a single number which is:

010001000110000101110100011001010011101000100000010101000110100001110101 001011000010000000110001001000000100101001110101011011000010000000110010 001100000011000000110100001000000011000100110110001110100011001000110010 001110100011010100110111001000000010110100110000001101000011000000110000 001000000010100001000101010001000101010000101001000011010000101001000110 011100100110111101101101001110100010000001110011011001010110111001100100 011001010111001000100000001111000111001101100101011011100110010001100101 011100100100000001110011011011110110110101100101011101110110100001100101 011100100110010100101110011011110111001001100111001111100000110100001010 010101000110111100111010001000000111001001100101011000110110100101110000 011010010110010101101110011101000010000000111100011100100110010101100011 011010010111000001101001011001010110111001110100010000000111001101101111 011011010110010101110111011010000110010101110010011001010010110101100101 000010100101001101110101011000100110101001100101011000110111010000111010 001000000110000100100000011101000110010101110011011101000010000001101101 001000000110000100100000011101000110010101110011011101000010000001101101 011001010111001101110011011000010110011101100101000011010000101000001101 000010100100100001101001001000000111010001101000011001010111001001100101 001011100010111000101110011101000110100001101001011100110010000001101001 011100110010000001100001001000000111010001100101011100110111010000100001 0000110100001010
or, more compactly, in hexadecimal notation:
446174653A205468752C2031204A756C20323030342031363A32323A3537202D30343 0302028454454290D0A46726F6D3A2073656E646572203C73656E64657240736F6D65 77686572652E6F72673E0D0A546F3A20726563697069656E74203C726563697069656 E7440736F6D6577686572652D656C73652E6F72673E0D0A5375626A6563743A20612 074657374206D6573736167650D0A0D0A48692074686572652E2E2E74686973206973 206120746573742100

In decimal, this is expressed as:

208030582921708828849129857495979513931498998513209388923645805068883608 305096643143263658005012971825285103233760253916458188501469134652281689 994141369086997945817281926445454417999759958297622834737446197741008031 526149337795027517469693237946079614321362696287936929689581998065794752 46065666953624806190191787487146452327163944652639733425709636902I906172 230583547511335471499460211955897225817826001473508538769639494565370554 8032

The above number is likely too long a number to ask the sender (or a third party) to try to factor. Using a hash function H(•), this can be reduced into a smaller, specified number of digits using a hash function. In this case, for illustration purposes this number is squared and its residue modulo 1234567 is obtained, resulting in 283070. Factored into primes this is: 283070=2*5*28307.

The above hash function H(•) was chosen for illustrative purposes only, since it is easy to understand. As mentioned above, any hash function H(•) could be used, particularly one that is non-local and thus is affected by the entire contents of the input and for which one cannot easily modify the input in order to generate a desired output. This may be advantageous, since someone intending to subvert the DOL system could try to generate messages which all hashed into a small number (possibly even one) of numbers whose factors had already been determined, or which could easily be determined, or which were in fact prime already (in the case of the algorithm described in the present example).

At step 810, the sender-side message processing function 704 assesses the effort (in this case, computational effort) that was expended in solving the computational problem. This can be done in a variety of ways such as by tracking elapsed time, counting CPU cycles, etc. The expended effort is denoted E*. In some embodiments of the present invention, the sender-side message processing function 704 infers the degree of effort expended in solving the computational problem using empirical techniques that are based on characteristics of the solution Z.

The sender-side message processing function 704 then proceeds to step 812, where the expended effort E* is compared to the minimum threshold effort E. If the expended effort E* is less than the specified minimum threshold effort E, the sender-side message processing function 704 proceeds to step 814, where the computational problem to be solved is modified so as to make it more computationally intensive.

For example, the work function F(•) may be modified to make it a more computationally intensive function, in which case the sender-side message processing function 704 returns to step 808. Alternatively, the string <M> may be modified to make computation of F(<M>) more difficult, in which case the sender-side message processing function 704 also returns to step 808.

In addition, or alternatively, the hash function H(•) may be modified so that it makes subsequent computation of the work function F(•) more computationally intensive, in which case the sender-side message processing function 704 returns to step 807. One can also adopt an approach whereby one cycles through a series of hash functions H1(•), H2(•), etc. until one comes across a problem that is “hard” to solve in some well defined manner (in the case of prime factoring, a “hard” problem may the factoring of a large number whose factors turn out to be two prime numbers of roughly the same size.)

In another embodiment, which may be applied in conjunction with the aforementioned modifications to the work function F(•) and/or the hash function H(•), the original message M is modified to make computation of F(<M>) more difficult, in which case the sender-side message processing function 704 returns to earlier step 806.

In the majority of cases, step 812 will eventually yield the result that the expended effort E* is greater than or equal to the minimum threshold effort E. When this occurs, the sender-side message processing function 704 constructs an augmented message 706 at step 816, which comprises the original message M and a DOL 714 that includes Z (i.e., the solution to the computational problem). In those cases where the condition of step 812 is not satisfied even after an inordinate (by some measure) number of time or attempts, then as a default measure, it is within the scope of the invention to exit the loop nevertheless and perform step 816 by constructing the augmented message 706 from the original message M and, say, the most recently produced DOL 714 message or the most “difficult” of the generated DOLs 714 or all of the generated DOLs 714, etc.

The DOL 714 may additionally include a definition of the work function F(•) (or its inverse F⁻¹(•)), the hash function H(•) plus whatever information is necessary to describe how M or <M> was modified in order to give rise to the appropriate expression of effort conveyed by the DOL 714. Alternatively, this information may be communicated over the data network 110 to the recipient in a separate message or via separate channel (e.g., for enhanced security).

Alternatively still, the definition of only one of these functions (i.e., either the work function or the hash function) is provided in the DOL 714, with the definition of the other function being conveyed to the recipient in a separate message or via a separate channel. For instance, consider the embodiment where the work function F(•) is a common one-way function (e.g., factoring into primes) for all messages, while the hash function H(•) is variable on a message-by-message basis. In this case, as is contemplated by FIG. 7, the definition of the work function F(•) (or its inverse F⁻¹(•)) could be communicated only once to both sender and recipient (e.g., through installation of the software), while the definition of the hash function H(•) is communicated in the DOL 714. Going one step further, the definition of the hash function H(•) could also be communicated separately (e.g., in a separate message or via a separate channel) for enhanced security.

At step 818, the augmented message 706 (consisting of the original message M and the DOL 714) is communicated to the recipient (e.g., via a data network 110).

Considering now the specific example described above, and assuming that the expended effort E* is at least as great as the minimum threshold effort E, the augmented message 706 may resemble the following (where the DOL is the last line and contains only Z):
Date: Thu, 1 Jul. 2004 16:22:57-0400 (EDT)
From: sender sender@somewhere.org
To: recipient recipient@somewhere-else.org
Subject: a test message
Hi there . . . this is a test!
283070=2*5*28307

In the specific example described above, the solution to the computational problem consisted of the prime factors 2, 5 and 28307. Owing to the presence of several small prime factors, relatively little work was required to factor this number, and this fact would also become apparent to the recipient if he or she received this particular augmented message 706. However, the sender is just as capable of realizing the poor offer of legitimacy being made and could change the message (e.g., by adding extra characters or a time stamp to the message body) and/or change the result of the conversion (i.e. <M>) and/or change the hash function H(•) that generated the number and/or perform a work function F(•) other than prime factoring, in order to result in a DOL that will be perceived as having a higher degree of legitimacy. Thus, the sender-side message processing function 704 can in certain embodiments preemptively computes the legitimacy score of a message and can make changes in the event that the legitimacy score is found to be too low.

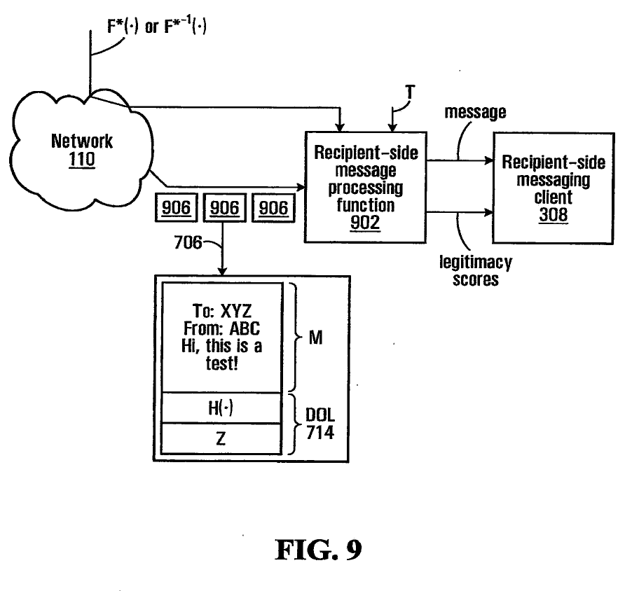

With reference to FIG. 9, at the recipient, the augmented message 706 is received by the recipient-side message processing function 902, which may be implemented as a software application executed by a computing device to which the recipient has access via an I/O. Examples of the computing device include without being limited to a personal computer, computer server, cellular telephone, personal digital assistant, networked electronic communication device (e.g., portable ones such as Blackberry™), etc. As described above, the augmented message 706 comprises a first part that constitutes the original message M as well as a second part that constitutes the DOL 714 which comprises the solution Z. In addition, the DOL 714 may comprise the definition of the work function F(•) (or its inverse F⁻¹(•) and the hash function H(•) used to generate the solution Z as well as any modifications to M or <M>. Alternatively, this information may be provided to the recipient in a separate message or via a separate channel.

It should be understood that in general, the recipient receives messages 906 that include messages other than the augmented message 706. Each of the received messages 906 may or may not contain a DOL and, if they contain a putative DOL, such putative DOL may or may not be a “valid” DOL (i.e., one which expresses the correct solution to a problem involving all or part of the associated message 906). Accordingly, the recipient-side message processing function 902 executes a process that begins by verifying whether a particular received message 906 contains a putative DOL and, if so, whether the putative DOL is valid and, if so, whether sufficient effort was expended by the sender.

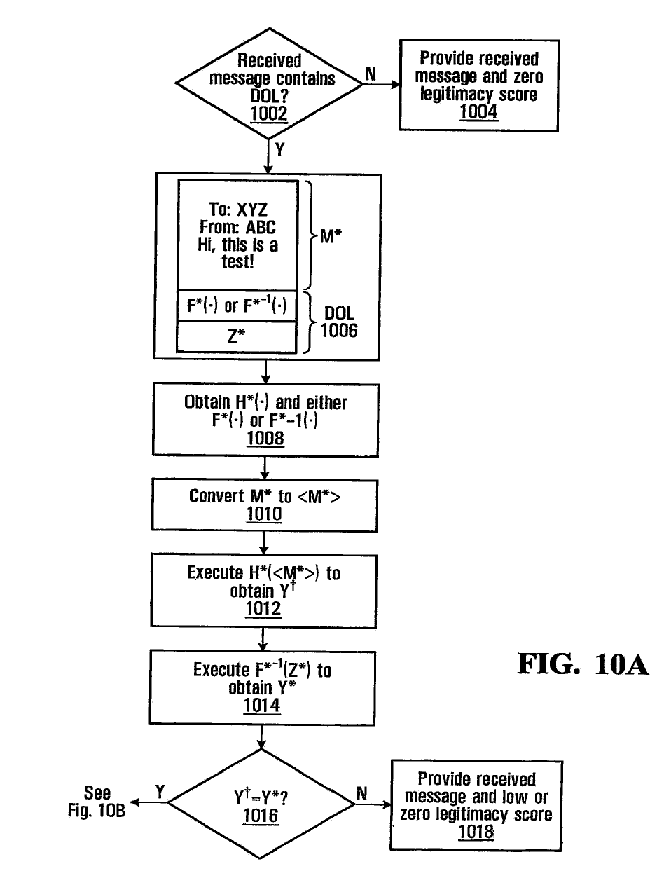

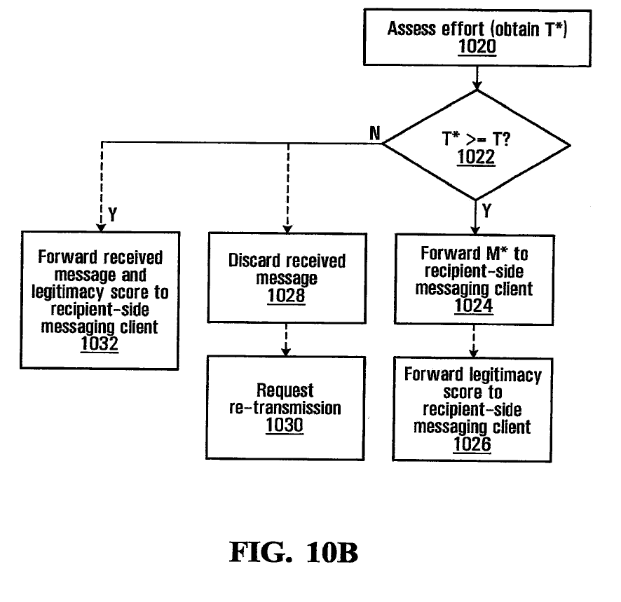

With reference to FIG. 10A, a specific non-limiting example embodiment of the process executed by the recipient-side message processing function 902 is shown. Specifically, at step 1002, the recipient-side message processing function 902 determines whether the received message 906 contains a putative DOL. If not, it can be said that the received message 906 carries a zero legitimacy score. At step 1004, both the received message 906 and the legitimacy score are provided to a recipient-side messaging client 308 for further processing. Alternatively, the received message 906 may be discarded.

However, if the received message 906 contains a putative DOL, then this means that the received message 906 is an augmented message which comprises an original message M* and a DOL 1006, which comprises a solution Z* to a computational problem, the definition of which has been provided to the recipient-side message processing function 902. The recipient-side message processing function 902 thus proceeds to establish the validity of the putative DOL 1006.

Specifically, at step 1008, the recipient-side message processing function 902 obtains knowledge of both the hash function H*(•) and the inverse F*⁻¹(•) of the work function F*(•) thought to have been used by the sender in computing the solution Z*. It will be understood that where the received message 906 is the augmented message 706, then the work function F*(•) will correspond to the work function F(•), the hash function H*(•) will correspond to the hash function H(•) and the asterisks in the following discussion can be ignored.

In certain embodiments, the definition of the hash function H*(•) and the definition of the work function F*(•) or of its inverse F*⁻¹(•) will have been contained in the received putative DOL 1006. In other embodiments, the definition of one or the other of these functions will be provided off-line or from the sender over an alternate channel via the data network 110.

Next, at step 1010, the recipient-side message processing function 902 converts the received message M* into a string <M*> and, at step 1012, applies the hash function H*(•) to <M*>, yielding a first intermediate value Y^{\}.

At step 1014, the recipient-side message processing function 902 computes F*⁻¹(Z*), namely it executes the inverse of the work function on the received solution Z*, thereby to obtain a second intermediate value Y*, which should match the first intermediate value Y^{\}. At step 1016, the first and second intermediate values are compared. If there is no match, then the recipient-side message processing function 902 can immediately conclude that the received DOL 1006 is invalid or bogus. Thus, it can be said that the received message 906 carries a low or zero “legitimacy score”. At step 1018, both the original message M* and the legitimacy score are provided to the recipient-side messaging client 308 for further processing. Alternatively, the received message 906 may be discarded. However, assuming that there is a match between Y^{\}and Y* at step 1016, the recipient-side message processing function 902 proceeds to execute a sub-process that will now be described with reference to FIG. 10B.

Specifically, at step 1020, the degree of effort expended in association with generation of the received message 906 is assessed and in some embodiments can be quantified as T*. This can be done in a brute force manner, e.g., by solving the same computational problem as the sender, i.e., F*(H*(<M*>)), and determining the time or CPU cycles required to produce the solution. Alternatively, it may be advantageous for the recipient-side message processing function 902 to render its own independent assessment without needing to perform the brute force calculation, based on knowledge of the work function F*(•), knowledge of the hash function H*(•), and possibly knowledge of the solution Z*.

For example, consider the case where F*(•) corresponds to factoring into prime factors Z*=p1, p2, p3, . . . In this case, the assessed effort (in some embodiments denoted by a specific value T*) may be related to factors such as:
(I) Whether F*(H*(<M*>)) was in some sense simple to compute (easy to factor), for example, either due to being a relatively small number, comprised of rather small primate factors or being prime itself.

Simplicity can be tested by numerous heuristic methods as well as by the straightforward method of having the recipient actually attempt to calculate F*(H*(<M*>)) itself without reference to the given value of Z*. For example, the assessed effort may be considered to be simple if H*(<M*>) has one or more small prime factors (which could be established quickly by techniques such as trial division) or is itself prime. This latter case discourages would-be spammers from trying to generate messages which hash into large primes.
(II) The portion of the received message M* that identifies the ancillary co-ordinates.

Specifically, date information in the received message M* could point to the received message M* having been generated long ago and the DOL 1006 computed by means of some relatively inexpensive resource.
(III) Whether the factors p1, p2, . . . are indeed prime.

Example approaches for doing so can be derived by one skilled in the art from the polynomial time algorithm described in the following pre-print: M. Agrawal. N. Kayal and N. Saxena, PRIMES is in P, Annals of Mathematics 160 (2004), 781-793. The reader is also referred to Section 2.5 of Andrew Granville, Bulletin of the American Mathematical Society, Vol 42 (2005), pp. 3-38, incorporated by reference herein. Alternatively, one can verify that the alleged factors are “extremely likely” to be prime via standard number-theoretic techniques. Here “extremely likely” can mean likely with essentially arbitrarily high degrees of confidence although not total certainty. For example, one may claim a factor to be prime with a probability so high that being mistaken is less likely than the recipient being hit by lightning during a 1 hour time period.

Note that using these latter techniques, it is easy to check with a very high probability that a number is prime in a very short amount of CPU time As examples in this regard, certain algorithms exist based on the notion of a “witness to compositeness”. The idea is that if one has a number Q which one would like to test for primality, a “witness” W to the compositeness of Q is a number such that g(Q,W) equals some specified value for some easy-to-evaluate function g if Q is composite, while otherwise one remains ignorant as to whether or not Q is composite from the test (see for instance the Solovay-Strassen test and the Miller-Rabin test described in the Handbook of Applied Cryptography, by A. Menezes, P. van Oorschot, and S. Vanstone, CRC Press, 1996), incorporated by reference herein. There are for example choices of g well-known to number theorists such that witnesses to the compositeness of any Q are more or less uniformly distributed below Q, and a randomly chosen number less than Q will be a witness a specified fraction of the time, for example in the case of the Solovay-Strassen test about half the time. The net result is that it is possible to establish with little effort that a number has any desired probability P (where P is less than 100%) of being prime. This is a useful means of checking primality with a good degree of confidence, which in certain embodiments would be sufficient for a message recipient to accept that the required effort was probably (rather than certainly) expended.

One can also allow the sender to send as part of Z* (i.e., the solution to the computational problem), a demonstration that the numbers are indeed prime via a certificate of primality (e.g., a Pratt certificate). For more information regarding primality certificates, the reader is referred to the aforementioned work by Andrew Granville. A particular primality certificate based on Fermat's little theorem converse is the Pratt Certificate. For more information regarding the Pratt Certificate in particular, the reader is referred to http://mathworld.wolfram.com/PrattCertificate.html, incorporated by reference herein, from which the following is an excerpt:
Although the general idea had been well-established for some time, Pratt became the first to prove that the certificate tree was of polynomial size and could also be verified in polynomial time. To generate a Pratt certificate, assume that n is a positive integer and {pᵢ} is the set of prime factors of n−1. Suppose there exists an integer x (called a “witness”) such that xⁿ⁻¹≡1(mod n) but x^{e}≢1(mod n) whenever e is one of (n−1)/pᵢ. Then Fermat's little theorem converse states that n is prime (Wagon 1991, pp. 278-279). By applying Fermat's little theorem converse to n and recursively to each purported factor of n−1, a certificate for a given prime number can be generated. Stated another way, the Pratt certificate gives a proof that a number a is a primitive root of the multiplicative group (mod p) which, along with the fact that a has order p−1, proves that p is a prime.

Next, at step 1022, the assessed effort T* is compared to a minimum threshold effort T. The minimum threshold effort T corresponds to a minimum effort required to have been expended in association with generation of a particular message in order for that message to be considered legitimate (i.e., to have a high legitimacy score). The minimum threshold effort T may be configurable by the recipient and may be the same as or different from the minimum threshold effort E used by the sender in some embodiments as described above.

If the assessed effort T* is at least as great as the minimum threshold effort T, then the recipient-side message processing function 902 proceeds to step 1024, where the original message M* is forwarded to the recipient-side messaging client 308. In addition, a legitimacy score may be assigned to the received message 906 and, at step 1026, forwarded to the recipient-side messaging client 308. The legitimacy score may be correlated with the extent to which the assessed effort T* exceeds the minimum threshold effort T.

However, if the assessed effort T* falls below the minimum threshold effort T, then a variety of scenarios are possible, depending on the embodiment. For example, at step 1028, the recipient-side message processing function 902 discards the received message 906 and, optionally at step 1030, requests that the received message 906 be re-transmitted by the sender. Alternatively, at step 1032, the received message 906 is sent to the recipient-side messaging client 308 along with an indication of a low or zero legitimacy score.

As previously described, the recipient-side messaging client 308 may be implemented as a software application executed by a computing device to which the recipient has access via an I/O. Examples of the computing device include without being limited to a personal computer, cellular telephone, personal digital assistant, networked electronic communication device (e.g., portable ones such as Blackberry™), etc. As has already been mentioned, the recipient-side messaging client 308 may implement a graphical user interface (GUI) that conveys to the recipient the various received messages and their associated legitimacy score.

For a more comprehensive example of how the algorithms disclosed herein above may be implemented in practice, consider the following programs written in C and which compile and run with GCC (GNU Compiler Collection) under Linux or Windows with Cygwin (a collection of free software tools originally developed by Cygnus Solutions to allow various versions of Microsoft Windows™ to act somewhat like a UNIX system) which allows the GCC to run under Windows™:

A similar working implementation, involving small changes to the implementation of the equivalent of the “unsigned long long int” data type appropriate for Microsoft Windows™, has also been written for the Microsoft Windows™ operating system and incorporated into Outlook™ with a GUI representing an embodiment of some of the mail sorting algorithms described in this patent.

Each of the above programs handles I/O through the standard input and output streams “stdin” and “stout”. The first, called makedol.c, expects as input 16 hexadecimal digits (0-F) represented as plain ASCII text which are the output of a hash function applied to the mail message in question. This latter number is far too large to be a good candidate for factoring, so a new number is constructed which is shorter. Many techniques could be considered, but what was done here as a concrete implementation was to take the hexadecimal digit “5” and append to it the first 13 (hex) digits of the hashed message given as input (so as to come up with a 14-digit hexadecimal number) and take this as the hash to work from. The use of the digit “5” was largely arbitrary, but the motivation was to be sure that the first digit of the 14-digit hexadecimal number was not zero (as it might have been for example, if one simply took the first 14 digits of the output of the above hash function), since having a zero as the first digit would lead to a smaller number to factor then desired and “5” seemed a good compromise with larger numbers in general taking longer to factor.

The result of applying the hash function is referred to as “n”. An attempt is then made to factor this number in the simplest way by trial division, with the understanding that all number theoretic tasks could also be implemented using the most appropriate, and likely more complex, algorithms in a commercial implementation. If the number n is prime, or if it is not the product of at least 2 large primes (where large is defined by BIGFACDEF) and thus represents a problem which is too easy, or if it is taking too long too factor since it has reached trial divisors as large as MAXFACTOR and is thus deemed to be too hard, n is incremented by 1 and this is repeated as often as needed to get a number which is neither too “hard” nor too “easy” to factor. Since numbers which are the products of at least 2 large primes are sufficiently common, it is likely that a suitably difficult problem (i.e., in the form of a large number which has large prime factors) will eventually be encountered after a certain amount of time or attempts. If not, then the aforementioned default measure can be applied.

The final DOL is constructed then as: <hashed message of 16 hex digits>:<number of increments of n needed>:<factors of n separated by colons and terminated with a colon>.

The process of checking the DOL is simple: the number derived from the 16 hex digit hash as described above (a “5” followed by the first 13 digits of the original hash that was fed to the DOL generator) plus the number of increments must be equal the product of the numbers claimed to be prime factors, and each of the numbers claimed to be prime factors must indeed be prime. In this implementation, primality is determined with absolute confidence by trial division by all possible factors (but could be determined using very fast probabilistic algorithms). This is not actually very time consuming on the checking side compared to the effort in making the DOL which requires the factoring of a much, much larger number. As noted elsewhere, this is a simple implementation and of course better number theoretic algorithms can be used.

Again, it should be emphasized that although the above examples have made specific reference to email messages, the messages themselves are not limited to email messages and may generally represent any communication or transfer or data. Specifically, the messages referred to herein above may contain a digital rendition of all or part of a physical communication such as conventional mail including letters, flyers, parcels and so on; text and/or video or other messages without limitation sent on phones; instant messages (i.e. messages sent via real time communication systems for example over the internet); faxes; telemarketing calls and other telephone calls; an instruction or instructions to a target computer such as a web-server; more generally to any information or communication sent by any electronic system for transmitting still or moving images, sound, text and or other data; or other means of communicating data or information.

### Embodiment Using Trapdoor Information

It might in certain circumstances make sense to use functions which are not one-way functions. For example, it might make sense to use a function whose value is difficult to compute in both directions unless one has an additional piece of information, referred to as “trapdoor information” and denoted W. Such a function turns into a one-way function when the trapdoor information W is known. The trapdoor information W may be kept secret (e.g., RSA™ token) or it may be publicly accessible (e.g., IP address of an IP phone).

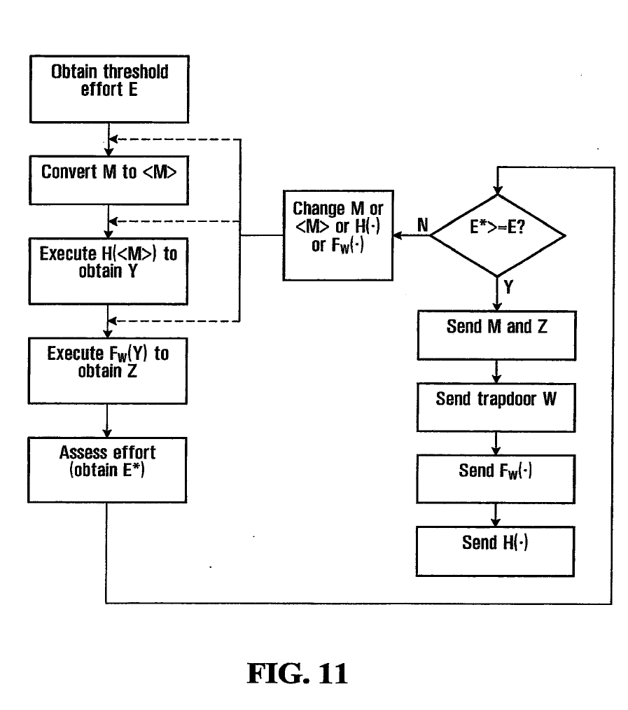

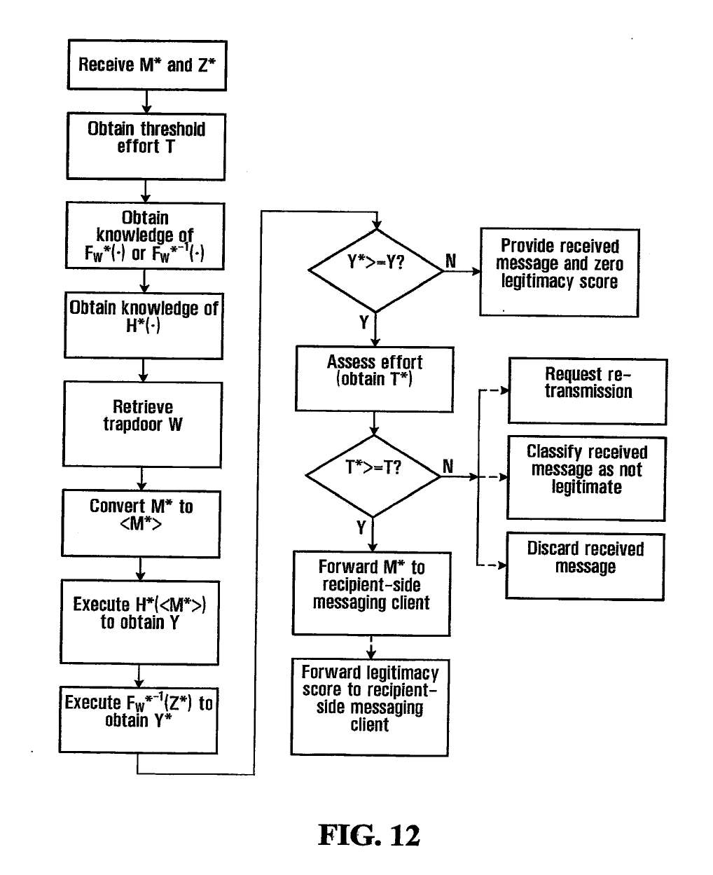

FIG. 11 shows an example process executed by the sender-side message processing function 102, in which trapdoor information W is used by the sender to execute the work function. The work function is in this case denoted F_{W}(•) and its inverse is denoted F⁻¹_{W}(•). The sender sends the trapdoor information W to the recipient to enable the recipient to compute the inverse function F⁻¹_{W}(•) with greater ease. FIG. 12 shows an example process executed by the recipient-side message processing function 302, in which the trapdoor information W is received from the sender and used by the recipient to facilitate execution of the inverse function F⁻¹_{W}(•).

The benefits of using the function F_{W}(•) include, without limitation, that only the recipient can verify which messages have authentic DOLs and/or “rank” mail communications. This would in turn allow someone for example to send one accurate (or “true”) message amongst a large number of inaccurate (or “false”) mail communications in order to confuse people who might intercept these messages. However, the recipient would be able to use the function F_{W}(•) plus the trapdoor W in order to see for example which messages had authentic DOLs, or in order to rank the messages with authentic DOLs in some manner, e.g., according to the legitimacy score of the received message. Such ranking could, for example, be combined with whitelisting or other criteria so that a sender who would expect their messages to be read based, for example, on their appearance on a whitelist, could indicate the seriousness or importance of a message through an attached DOL.

In an alternative embodiment, the sender could choose not to convey the trapdoor information to the recipient, or alternatively choose not to convey it to anyone. In this latter case, for example, only the sender would be able to rank which messages or communications were legitimate. This approach could find application in a number of areas, for example when a browser (sender) is surfing the web he may choose to not have his web surfing history known to outside parties. In this instance, one could envisage his browser visiting sites automatically and when doing so generating spurious (and potentially easy to compute, in some embodiments) DOLs for these communications (in this case, for these web server requests). When said browser (sender) is himself visiting websites, his computer could generate legitimate DOLs. Since only the browser (sender) knows how to verify these DOLs, only the browser (sender) would be able to verify what his true web surfing history was—whereas outside parties would be confounded by all the “noise” generated by the automatic browsing his web browser did without attaching legitimate DOLs.

Embodiment that Takes into Account Urgency

Since the generation of a DOL could be made sensitive to spatio-temporal co-ordinates, it is possible to express not only legitimacy as described above, but also an additional quality which can be referred to as “urgency”. That is to say, a message requesting urgent action—which had a DOL including date and time information—received by a recipient within a short time interval of being sent would be indicative of the relevant computational resources required to generate the DOL having been not merely applied but applied at a high level of priority in the operating system sense of the word. Since a resource like large amounts of computation on demand at short notice in general costs more than it would if it could be had at lower priority (the extreme case being so-called “spare cycles”), a good DOL based on a hash function incorporating date/time information can be used to convey the notion of urgency.

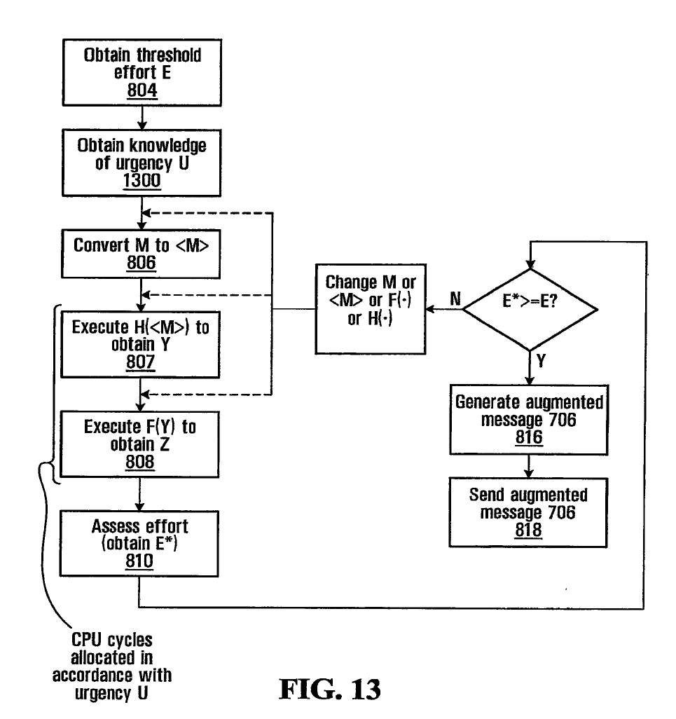

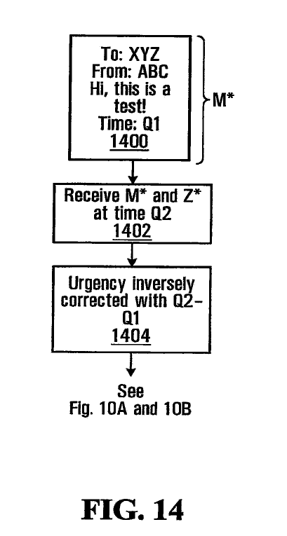

FIG. 13 shows an example process executed by the sender-side message processing function 102 (similar to the flowchart in FIG. 8), in which knowledge of the “urgency” is taken into account at step 1300 and is used to influence the allocation of CPU cycles used to execute steps 807 and 808. FIG. 14 shows an example process executed by the recipient-side message processing function 302, in which the urgency is assessed at steps 1400-1404, following which the remainder of the message processing is as previously described with reference to FIGS. 10A and 10B.

Depending on the implementation schemes adopted, the urgency of a message could potentially be faked by a putative spammer. For example, one could envision a putative spammer faking a date sometime in the future and then computing a DOL for later transmission. However, this approach could be defeated by introducing some form of time-stamping or by introducing a dependency on some unpredictable piece(s) of information, such as the price of a given stock at a given time or other ancillary data as described earlier.

### Embodiment Using Cascaded DOL Generation

In certain circumstances, one may be concerned about attempts to generate DOLs using large compute farms—in parallel or otherwise—in which case one might wish to ensure that a DOL is generated in a fashion which does not allow the work to be divided amongst many machines. For example, once one has generated a DOL according to any of the schemes described herein above, one can consider the augmented message (i.e., original message augmented by the DOL) as a new message in its own right. One can then request that a DOL be generated for the augmented message, resulting in a further augmented message. This can be repeated any number of times, with each augmented message representing a new problem on which work cannot be started, no matter how many machines one has, until the previous message (augmented by the DOL) has been generated—that is to say, until the previous DOL has been calculated. A significant corollary of the fact that a DOL-augmented message is itself a message is that DOL generation can be not only iterated, but can be freely mixed in any order with encryption, compression, or any other message processing as required or desired in any order and any number of times.

Note that one can in fact adopt this approach as a standard embodiment of the DOL approach on a single sender's machine. Proceeding in this manner, one could—as an example, without limitation—ensure that the hash function at each iteration yields a “moderately” simple problem to solve (i.e. one which can be done relatively quickly), but that this process needed to be iterated a certain number of times. In this case one needs, however, to continue to ensure that it is easy for the intended recipient to verify that the entire sequence of iterative DOL calculations has been correctly done (and to this end one could, without limitation, also include certificates of primality or similar items at each stage, which render the recipients work of checking the calculations easier).

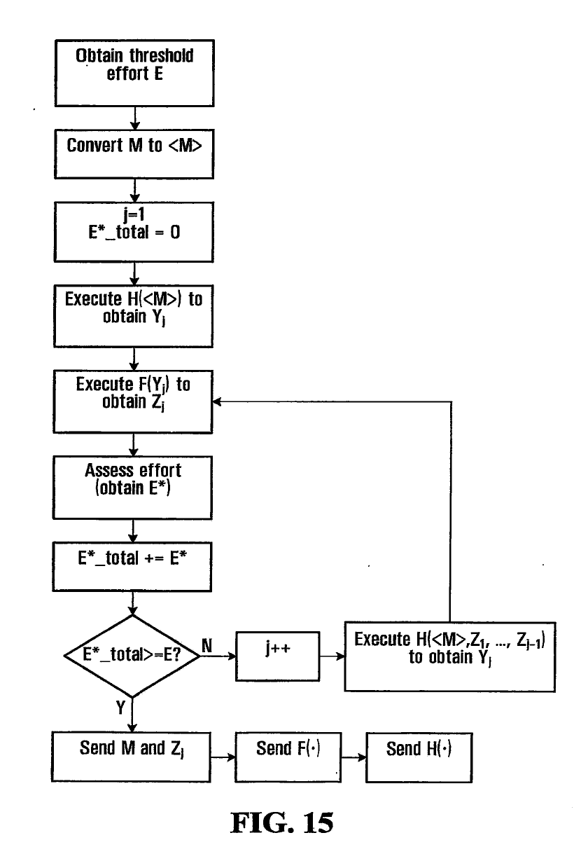

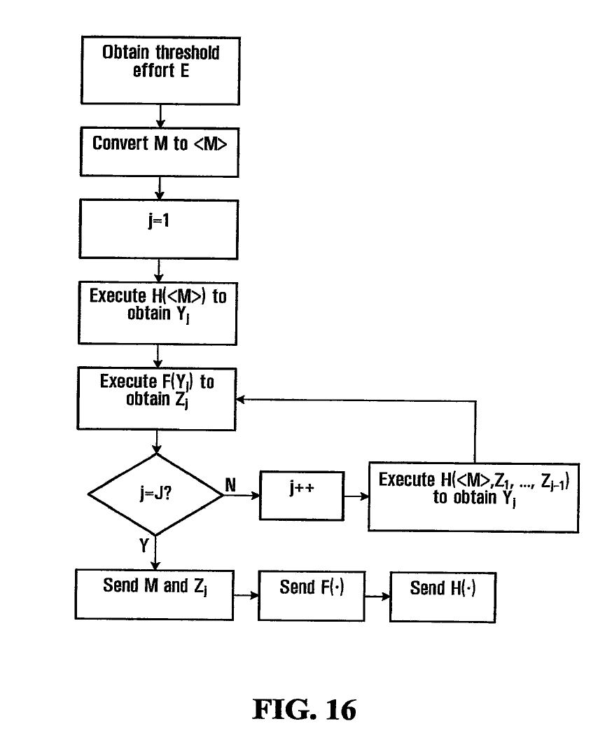

The generation process is shown in FIG. 15 for the case where the hash function is repeated on successively augmented messages (H(<M>), H(<M>,Z1), H(<M>,Z1,Z2) etc.), as many times as necessary before the total cumulative expended effort E*_total amounts to at least the threshold effort E. Alternatively, FIG. 16 shows the case where the hash function is repeated on successively augmented messages a fixed number of times J.

### Embodiment Using Third-Party DOL Generation

The effort entailed in generating a DOL in the present context could be subcontracted to organizations, companies or others who are willing to provide the requisite computational resources. In fact, a new form of business may be created based on performing the calculations required to generate DOLs for a fee (in essence a private “Post Office”).

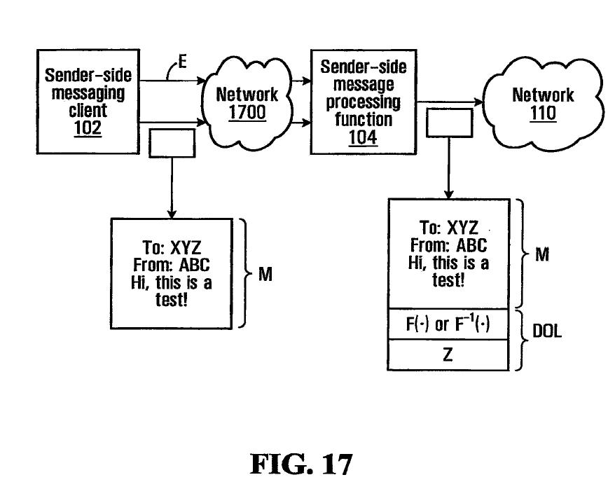

This is shown by way of non-limiting example in FIG. 17, where the sender-side message processing function 104 is a third party, connected to the sender-side messaging client 102 by a first network 1700 and is also connected to the recipient via a second network 110 (which may or may not be the same as the first network 1700). In this embodiment, the sender-side messaging client 102 provides the (third party) sender-side message processing function 104 with the appropriate degree of effort (for example exceeding the threshold effort E) via the network 1700.

Similarly, on the recipient side, the effort entailed in determining the legitimacy score of a received electronic message could be subcontracted to organizations, companies or others who are willing to provide the requisite computational resources. In fact, a new form of business may be created based on performing the calculations required to establish the legitimacy of received electronic messages for a fee (again, in essence, a private “Post Office).

### Further Observations and Applications

Those skilled in the art will therefore appreciate that because the function F(•), rather than being completely predetermined, can be specified by the sender, it allows a recipient to rank incoming messages by DOL, rather than labeling them simply as “spam” or “legitimate mail”. Also, this allows the recipient, if desired, to combine the DOL measure with any other spam filtering techniques that are currently in use or will be introduced in future.

Furthermore, in certain embodiments, the recipient can demand that a sender perform some work in order to demonstrate that a message really is important and even more than that, a recipient can request that a sender quantify how important the sender feels the message is.

The flexibility in choice of F(•) allows the sender to gauge the amount of work done, and adjust this to express varying degrees of interest in having the recipient read the message being sent. It also allows the sender to detect fluke situations in which the actual work done turns out to be much less than had been anticipated and choose a different, demonstrably harder task. Again, it should be reiterated that it is also within the scope of the present invention for the sender to ensure that the degree of effort expended in generating the DOL is within a certain range (rather than simply being greater than a threshold) or for the sender not to assess the effort at all (expecting or knowing, for example, that the vast majority of the time the effort will be sufficient, etc.). This affects the instances in the above description where E* was compared to E, and when in fact it is within the scope of the present invention to check whether E* is within a certain range (that may in fact be bound below by the threshold effort E or not to check E* at all).

Moreover, the techniques described herein make no assumptions about the nature of the message (so one could for example mention pharmaceuticals such as Viagra™, Cialis™, or other products that most spam filters are very likely to filter out—even if the communication is a legitimate one, say between a physician and a patient) and do not require that the recipient recognize the sender, although any available filters based on content, originator, Bayesian techniques, whitelists/blacklists, etc. can be used concurrently with the approach described herein.

The techniques described herein as already noted above can also be freely combined with any form of processing of the original message including but not limited to encryption (steganographic or otherwise), compression and watermarking, and these forms of processing may in addition, or alternatively, be applied to the augmented message.

Moreover, the approach described herein can in many applications be implemented in such a manner that requires no significant changes to the basic infrastructure used for any form of communication, since many embodiments of the present invention merely require sending a small amount of additional data as a DOL. The approach described herein allows a sender to express an arbitrary degree of legitimacy via an arbitrarily difficult calculation. Stated differently, the approach described herein enables someone to spend a variable amount of resources to get someone else's attention. By communicating a demonstration of legitimacy (the effort involved in which is quantifiable in certain embodiments), this can be easily checked by a recipient in order to thereafter decide how to deal with the message.

It will be appreciated by those skilled in the art that one non-limiting example application of the present invention includes the control of unwanted or unsolicited messages, commonly referred to as “spam”. More specifically, applications include ways of dealing with electronic spam (in communication media which include without limitation: e-mail, fax, text messaging services, instant messaging services, telemarketing calls and so on).

Other non-limiting example applications of the present invention include the new business opportunities that arise as a consequence of the adoption of this technology, including without limitation the provision of services which will allow individuals initiating communications to demonstrate their legitimacy of intent to recipients.

The DOL approach described herein above can also be extended, without limitation, to telephony (including, without limitation, to “Voice over IP” or “VoIP” telephony), voice-mail (including without limitation to VoIP voice-mails), faxes (including without limitation to VoIP faxes or other electronic facsimile services) and any other media, either electronic or where the ultimate communication is in a form that either requires additional work to convert the message into electronic form (e.g. faxed material which would need to be turned into text by means such as optical character recognition, or normal telephone voicemails which could for example be converted into a text by speech recognition software) and/or is such that the information is only communicated once the connection has been made (for example normal telephone conversations).

One readily implementable means of extending the DOL approach to encompass additional media is, without limitation, to create a DOL problem for the recipient to validate. It might for example be sufficient to generate a DOL-problem via a hash function that has as inputs the address (i.e. the equivalent of e-mail address) of the recipient (or person being called), the address of sender (or caller) and possibly additional information such as the date, for example via some form of time-stamping. One might though want to make the DOL-implementation more robust by, for example, automatically contacting or pinging the recipient before initiating the communication to obtain a data element (e.g., pseudo-random number) and include this number in the DOL task as well.

It should be noted that DOL generation in the preceding paragraph, which only depends on the sender's and recipient's co-ordinates, might not constitute enough data for a sufficiently difficult DOL-computation to be carried out. Accordingly, another way of extending the DOL concept to cover applications in the paragraph immediately above is to add “pepper” to the DOL-problem. This may be described in a non-limiting example embodiment as including additional information (“pepper”) in some well-defined some way (e.g., augmenting the text of the message with additional characters) so that it hashes into a more challenging problem and sending the “pepper” as part of the description of the hash function. Note that in this instance, one would though also need some information that varied with time—i.e. a time-stamp—since otherwise a telemarketer, for example, would only need to do this computation once and could then re-use it. This notion of adding “pepper” could optionally be combined with the notion, mentioned in the paragraph immediately above, of pinging the recipient to obtain a data element such as a pseudo-random number.

Another application of the DOL generation approach is in the area of television messages and other broadcast media, including but not limited to advertising or commercials where, for example, an Internet Protocol television (IPTV) or video-over-IP recipient could be alerted as to the degree of effort expended by the sender in order to express the sender's seriousness in having the recipient view the sender's message. This opens up new vistas in advertising where, for example, multiple advertisements could appear in a streaming video where only the ones having a DOL with a sufficiently high legitimacy score are shown to the recipient. This can be envisaged as advertisers, or more generally would-be communicants with a recipient, “bidding” for viewer attention by offering DOLs of different computational complexity. Also, this enables targeted advertising by allowing an advertiser to show that a message was actually intended for a particular viewer or class of viewers, as well as permitting a viewer to choose only to see advertising that cost more than some set value to generate, or alternatively to rank the efforts made by various advertisers to get his/her attention. The approach described herein can also be applied to advertising in all other media—whether electronic or otherwise—including without limitation to pop-up advertising on the web, billboards, location-specific advertising of all varieties, advertising via cell-phones or other mobile communication devices, and so on.

Also within the scope of the present invention is establishing the legitimacy of a message than can be digitized, i.e. converted into a number, which is to say to any form of message whatsoever. This means, for example, that even physical mail or a parcel could be turned into a number—by scanning, for example, part or all of the document. Scanning a part of the document would constitute an implicit form of hash code generation. For example, someone sending a catalogue might well choose to demonstrate legitimacy just for the cover of the catalogue and then allow the recipient to choose whether or not to bother with any particular pages of the catalogue. Once all or part of a physical communication had been turned into a number, a DOL could be produced and sent by any means convenient—including, but not limited to, directly printing it on the package so it can be later read electronically or by other means, or sending the number electronically via some other channel. Scanning of some or all of the document could be performed by the recipient or some trusted intermediary—for example a commercial service—in order to verify that the purported DOL was authentic. The same principle, including the possibility of demonstrating legitimacy using only part of a message as part of an implicit hash code, applies to faxes sent via telephone lines or otherwise, telemarketing and other telephone communications (including, but not limited to Voice Over IP or VoIP), instant messaging services, mobile phone services (whether calls, text messaging etc.).

An additional specific application in the context of electronic messages over and above email is for messages arising from interactions with a webpage. For example, a web server could tag pop-up windows (for example containing pop-up advertisements or other information) with a DOL to indicate to a browser (receiver) that the information being offered in the pop-up window is indeed of a legitimate nature (for example, that the sender—advertiser etc.—is sufficiently interested in having the pop-up advertisement viewed by the browser, or recipient, that the sender has spent adequate computational resources to demonstrate this).

One can also envisage a wide range of new applications of the aforementioned DOL approach in the context of cell phones, as well as other portable and non-portable electronic devices. In one non-limiting embodiment, owners of cell phones use DOL-software to insist that those wishing to communicate with them electronically need to have their communications (or potentially a request to initiate communication, in the case of voice conversations—for example) be accompanied by a suitable DOL. In this case, the senders could either generate the DOL on their own devices—whether portable or non-portable—or have this done by their service provider or indeed by another outside party. Similarly, the recipients could either validate the DOL calculation on their device or have this done by their carrier or another outside party.

The approaches described herein could also be used to control the spread of viruses, which usually propagate by means of indiscriminate communication with other machines connected though the internet or by other electronic means.

The approaches described herein could also be used to address a wide range of electronic attacks against web-sites, for example “denial of service” attacks, where numerous spurious access requests are initiated against a given computer server (e.g., web site) or database. For example, a DOL may be required for each access request or may be used to rank access requests received in order of priority (by legitimacy score), just as was proposed above in the context of mail. Examples of entities which might find such services useful include web sites offering free services (such as Google™ searches) as well as sites which charge for each access request.

In a related vein, individuals wishing to purchase a product electronically—for example on-line at a specific web-site—could be required to provide a DOL.

The invention described herein could be particularly useful within organizations, particularly large ones, where there is a tendency amongst employees, consultants or others to carbon copy (“cc”), blind carbon copy (“bcc”) or forward messages to large numbers of people. This tendency often results in a loss of productivity at these organizations, as people find themselves subjected to large numbers of e-mails—many of which are of little to no relevance to them. By adopting the approach described herein, organizations will be able to exert control over this problem by ensuring there is a cost (in terms of resources) associated with sending people e-mails. In addition, organizations, will be able to increase or decrease this cost as they choose, by using computations or algorithms of variable difficulty as described herein.

Another opportunity to generate new businesses by virtue of the approaches described here includes the sale of ancillary information described earlier. This can be done through observation of external phenomena such as stock prices etc. as well as through computation based on deterministic (including pseudorandom) calculations, possibly based on other phenomena or through devices or processes created or exploited to produce such ancillary data, including those which are, according to current understanding, truly random (for example quantum mechanical processes.

Another opportunity to generate new businesses by virtue of the approaches described herein includes the sale of mail software that includes algorithms which implement DOL generation and/or verification, whether in the context of e-mail, telemarketing and other telephone communications, instant messaging services, mobile phone services (including text, calls etc.), physical communications and so on. These sales could be made to senders and recipients alike, or to existing providers of communications services or additional parties; such software could be sold in a variety of ways including without limitation as part of a stand-alone mail application, or as a plug-in that works with an existing e-mail and/or other applications sold by third parties, and so on.

The approaches described herein could be licensed to a vendor (software or otherwise), who could directly incorporate the approach described herein within their product, offer it as a separate option and so on.

Alternative approaches of commercializing the technology include making the software free up to some maximum number of messages or messages (perhaps per day or some other specified period), after which some licensing fee would be charged (this approach would be directed at identifying commercial users, for example).

The above described software could be sold in such a manner that the software required to generate a DOL requires payment, while the software required by the recipient to process this DOL is free, or vice versa; alternatively both parties could be required to purchase their software

It is furthermore envisaged that one could see the emergence of an economy in which units of computation serve as fungible currency which can be used to purchase articles, services etc. The approaches described herein can readily be implemented within such a context, and indeed the approaches described herein provide an example of how such a currency system could be made to work.

It should also be appreciated that the fact that DOLs can be generated by various different processes (e.g. different hash or work functions) means that the choice of process can be used to make the DOL communicate more than just legitimacy, but also to allow messages to be classified as to purpose, group membership, etc. For example, one user could potentially have two different work functions for use with different groups (e.g. a “personal work function” and a “business work function”), thus allowing messages to be segregated and steered towards different in-boxes. One could similarly envisage senders being able to choose from an “urgent work function” or a “non-urgent work function”—for a given recipient—which means the message upon arrival could accordingly be steered into “urgent” and “non-urgent” inboxes. In such an implementation, information about the required DOL generation technique (i.e., which process to use) can be agreed upon previously or provided by a recipient to a potential sender.

Again, it is reiterated that one can freely mix any other conceivable form of processing of a message (including DOL generation itself) with DOL generation in any order and any number of times.

The approaches described herein can furthermore be used by those service providers which allow subscribers (or sender or users) to send communications (as an example without limitation, Internet Service Providers such as Earthlink™ or webmail providers such as Hotmail™, Gmail™, Yahoo™ etc. which allow users to open accounts and send e-mail) to demonstrate that communications originating from said service providers (e.g. in the case of Hotmail™, e-mails originating from the hotmail.com domain) are not bulk unsolicited electronic communications or spam. This can be done by requiring that all users (or senders) attach valid DOL tags on all outgoing messages, whether or not the recipients of said messages can verify (or process) DOL tags or not. The service provider in question can monitor compliance, on the part of its users, with the requirement that all outgoing message have a DOL tag attached to them by either verifying every DOL tag on every message (which is feasible, given the speed with which DOLs can be verified) or by sampling messages sent by its users. Failure on the part of a user (or sender) to attach valid DOL tags on outgoing communications can then be flagged by the service provider and appropriate actions taken. Implementation of such policies will allow the service provider in question to claim that it is a spam-free domain, and that hence traffic originating from it should not be blocked.

Those skilled in the art will appreciate that in some embodiments, the functionality of each of the various sender-side messaging clients, sender-side message processing functions, recipient-side message processing functions and recipient-side messaging clients of the present invention may be implemented as pre-programmed hardware or firmware elements (e.g., application specific integrated circuits (ASICs), electrically erasable programmable read-only memories (EEPROMs), etc.), or other related components. In other embodiments, each of the various sender-side messaging clients, sender-side message processing functions, recipient-side message processing functions and recipient-side messaging clients of the present invention may be implemented as an arithmetic and logic unit (ALU) having access to a code memory which stores program instructions for the operation of the ALU. The program instructions could be stored on a medium which is fixed, tangible and readable directly by the various sender-side messaging clients, sender-side message processing functions, recipient-side message processing functions and recipient-side messaging clients of the present invention, (e.g., removable diskette, CD-ROM, ROM, or fixed disk), or the program instructions could be stored remotely but transmittable to the various sender-side messaging clients, sender-side message processing functions, recipient-side message processing functions and recipient-side messaging clients of the present invention via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

While specific embodiments of the present invention have been described and illustrated, it will be apparent to those skilled in the art that numerous modifications and variations can be made without departing from the scope of the invention as defined in the appended claims.

1. A method, comprising:
receiving an electronic message;
assessing a degree of effort associated with a generation of the electronic message;
further processing the electronic message in accordance with the assessed degree of effort.

2. The method defined in claim 1, wherein the electronic message has a first portion comprising an original message and a second portion comprising a result of solving a computational problem involving at least a portion of the original message, and wherein said assessing a degree of effort associated with a generation of the electronic message comprises assessing a degree of effort associated with solving the computational problem.

3. The method defined in claim 2, wherein the computational problem is defined by a definition, wherein said assessing a degree of effort associated with solving the computational problem is performed on a basis of the definition of the computational problem.

4-7. (canceled)

8. The method defined in claim 2, wherein solving the computational problem comprises converting the at least a portion of the electronic message into an original string and executing a computational operation on the original string to obtain said result, the method further comprising:
applying an inverse of the computational operation to said result, thereby to obtain a reconstructed string;
determining whether the reconstructed string corresponds to the original string;
wherein said assessing a degree of effort associated with solving the computational problem is performed responsive to the reconstructed string corresponding to the original string.

9. The method defined in claim 8, further comprising:
obtaining knowledge of the computational operation from a sender of the electronic message.

10-18. (canceled)

19. The method defined in claim 2, wherein solving the computational problem comprises converting the at least a portion of the electronic message into an original string, executing a first computational operation on the original string to obtain a first intermediate product and executing a second computational operation on the first intermediate product to obtain said result, the method further comprising:
executing the first computational operation on the original message to obtain a second intermediate product;
executing an inverse of the second computational operation on said result, thereby to obtain a second intermediate product;
determining whether the second intermediate product corresponds to the first intermediate product;
wherein said assessing a degree of effort associated with solving the computational problem is performed responsive to the second intermediate product corresponding to the first intermediate product.

20. The method defined in claim 19, further comprising:
obtaining knowledge of at least one of the first computational operation and the second computational operation from a sender of the electronic message.

21-43. (canceled)

44. The method defined in claim 1, wherein said further processing the electronic message in accordance with the assessed degree of effort further comprises:
responsive to the assessed degree of effort not exceeding the threshold, classifying the electronic message as potentially not legitimate.

45. The method defined in claim 1, wherein said further processing the electronic message in accordance with the assessed degree of effort comprises:
determining whether the assessed degree of effort exceeds a threshold;
responsive to the assessed degree of effort exceeding the threshold, classifying the electronic message as legitimate.

46. The method defined in claim 45, wherein said further processing the electronic message in accordance with the assessed degree of effort further comprises:
responsive to the assessed degree of effort not exceeding the threshold, classifying the electronic message as potentially not legitimate.

47. The method defined in claim 1, wherein said further processing the electronic message in accordance with the assessed degree of effort comprises:
determining whether the assessed degree of effort falls below a threshold;
responsive to the assessed degree of effort falling below the threshold, requesting re-transmission of the electronic message.

48-62. (canceled)

63. The method defined in claim 1, further comprising assessing a degree of urgency associated with the electronic message.

64. The method defined in claim 63, wherein the electronic message has a first portion comprising an original message bearing a time stamp indicative of a first time instant and a second portion comprising a result of a computational operation involving at least a portion of the original message, wherein the electronic message is received at a second time instant and wherein said assessing a degree of urgency associated with the electronic message comprises:
determining a time interval between the first time instant and the second time instant;
the degree of urgency associated with the electronic message being inversely correlated with said time interval.

65-86. (canceled)

87. A method of processing an electronic message destined for a recipient, comprising:
solving a computational problem involving at least a portion of the electronic message, thereby to produce a solution to the computational problem;
assessing a degree of effort associated with solving the computational problem;
further processing the electronic message in accordance with the assessed degree of effort.

88. The method defined in claim 87, wherein said solving a computational problem comprises converting the at least a portion of the electronic message into an original string and executing a computational operation on the original string.

89-96. (canceled)

97. The method defined in claim 87, wherein the computational problem is defined by a definition, wherein said assessing a degree of effort associated with solving the computational problem is performed on a basis of the definition of the computational problem.

98-106. (canceled)

107. The method defined in claim 87, wherein further processing the electronic message in accordance with the assessed degree of effort comprises:
determining whether the assessed degree of effort exceeds a threshold;
responsive to the assessed degree of effort exceeding the threshold, transmitting the electronic message to the recipient and informing the recipient of the solution to the computational problem.

108-112. (canceled)

113. The method defined in claim 107, the computational problem being an initial computational problem, wherein further processing the electronic message in accordance with the assessed degree of effort further comprises:
responsive to the assessed degree of effort not exceeding the threshold:
(a) solving a new computational problem involving at least a portion of the electronic message, thereby to produce a solution to the new computational problem;
(b) assessing a degree of effort associated with solving the new computational problem;
(c) further processing the electronic message in accordance with the assessed degree of effort associated with solving the new computational problem.

114-136. (canceled)

137. The method defined in claim 107, the computational problem being an initial computational problem, wherein further processing the electronic message in accordance with the assessed degree of effort further comprises:
responsive to the assessed degree of effort not exceeding the threshold:
modifying the electronic message to create a modified electronic message;
solving a new computational problem involving at least a portion of the modified electronic message;
assessing a degree of effort associated with solving the new computational problem;
further processing the modified electronic message in accordance with the assessed degree of effort associated with solving the new computational problem.

138. The method defined in claim 137, wherein further processing the electronic message in accordance with the assessed degree of effort associated with said solving the new computational problem comprises:
determining whether the assessed degree of effort associated with solving the new computational problem exceeds the threshold;
responsive to the assessed degree of effort associated with solving the new computational problem exceeding the threshold, transmitting the modified electronic message to the recipient and informing the recipient of the solution to the new computational problem.

139-149. (canceled)

150. The method defined in claim 113, the computational problem being an initial computational problem, wherein further processing the electronic message in accordance with the assessed degree of effort further comprises:
responsive to the assessed degree of effort not falling within the predetermined range:
modifying the electronic message to create a modified electronic message;
solving a new computational problem involving at least a portion of the modified electronic message;
assessing a degree of effort associated with solving the new computational problem;
further processing the modified electronic message in accordance with the assessed degree of effort associated with solving the new computational problem.

151-158. (canceled)

159. The method defined in claim 113, the computational problem being an initial computational problem, wherein further processing the electronic message in accordance with the assessed degree of effort further comprises:
responsive to the assessed degree of effort not falling within the predetermined range:
combining the electronic message with the solution to the initial computational problem to create a modified electronic message;
solving a new computational problem involving at least a portion of the modified electronic message;
assessing a degree of effort associated with solving the new computational problem;
further processing the modified electronic message in accordance with the total assessed degree of effort associated with solving the initial computational problem and solving the new computational problem.

160-199. (canceled)

200. The method defined in claim 1, wherein said further processing the electronic message in accordance with the assessed degree of effort comprises:
determining whether the assessed degree of effort exceeds a threshold;
responsive to the assessed degree of effort exceeding the threshold, causing the electronic message to be displayed on a screen.

201. (canceled)

202. A method, comprising:
receiving a plurality of electronic messages;
assessing a degree of effort associated with a generation of each of the electronic messages;
causing the electronic messages to be displayed on a screen in a hierarchical manner on a basis of assessed degree of effort.

203. (canceled)
